(19) United States
(12) Patent Application Publication
(10) Pub. No.: US 2019/0278818 A1
(43) Pub. Date: Sep. 12, 2019

(54) USER CREATED CONTENT REFERRAL AND SEARCH

(71) Applicant: MUDPIE, SA DE CV, Roma (MX)

(72) Inventor: Mildred Maria Villafane, Lomas de Chapultepec (MX)

(21) Appl. No.: 16/273,063

(22) Filed: Feb. 11, 2019

Related U.S. Application Data
(60) Provisional application No. 62/639,445, filed on Mar. 6, 2018.

(51) Int. Cl. G06F 16/9535; G06F 16/955; G06F 16/9536; G06F 16/901

(52) U.S. Cl. CPC G06F 16/9535; G06F 16/901; G06F 16/9536; G06F 16/955

(57) ABSTRACT

The technology described herein relates to systems and methods that use content, comments, and recommendations from users to build a searchable database of information that is informed by identifiable users. A search of this information provides results that are directly relevant to the user performing the search, and more reliable due to the searched information coming from a known and trusted population of users. Users begin with a basic content entry user interface (a “content referral”) to enter media content, comments, ratings, and reviews associated with something or someone. A user's top-ranked products, things, or people in each of multiple categories is calculated according to a scoring system. Users are able to follow users and/or ranked lists of people, places, or things (e.g., companies, people, products, brands, etc.) in which they are interested.

### CROSS-REFERENCE TO RELATED APPLICATION

This application claims priority to U.S. Provisional Patent Application No. 62/639,445 filed on Mar. 6, 2018, which is entirely incorporated by reference herein.

### BACKGROUND

Of the many promises realized from the development of the Internet and ubiquitous access to the World Wide Web, search applications and social network applications are arguably the two types of applications that have had the most profound effect on the world's population. When efficient search engines such as Google® and Yahoo!® became available, Internet users were able to quickly locate virtually any kind of information. When social networks such as MySpace® and Facebook® grew to service over a billion users, their users had a new way to exchange information, either with people they already knew, with people who knew friends, with unknown people such as potential customers, etc. It is hard to imagine life today without these innovations.

Over time, the two concepts merged and information related to search began to be used in social media and vice versa. This confluence of the two technologies has led to what some see as an over-commercialization of their personal information collected from social media applications. It has also led to corrupted search results that make it more difficult for a user to find exactly what the user is searching for, due to advertisers and aggregators taking many of the top listings in a search result, and due to information from a user's social network being included—implicitly or explicitly—in a search without the user's knowledge.

This corruption of search results and lack of privacy and information have created a need for a more efficient way for users to search for reliable information about products, places, people, and the like.

### BRIEF DESCRIPTION OF THE DRAWINGS

The Detailed Description, below, makes reference to the accompanying figures. In the figures, the left-most digit(s) of a reference use of the same reference numbers in different figures indicates similar or identical items.

FIG. 1 is a representation of a smart phone depicting an example user interface that is used to create a content referral.

FIG. 2 is a flow diagram that depicts an example methodological implementation for creation of a content referral for use in the techniques presented herein.

FIG. 3 is a representation of an example smart phone displaying an example base view user interface in accordance with the techniques described herein.

FIG. 4 depicts a smart phone displaying an example user interface in a capture view state of a content referral creation process.

FIG. 5 depicts a smart phone displaying an example user interface in a first naming view state of a content referral creation process.

FIG. 6 depicts a smart phone displaying an example user interface in a second naming view state of a content referral process.

FIG. 7 depicts a smart phone displaying an example user interface in a first category identification view state of a content referral process.

FIG. 8 depicts a smart phone displaying an example user interface in a second category identification view state of a content referral process.

FIG. 9 depicts a smart phone displaying an example user interface in a third category identification view state of a content referral process.

FIG. 10 depicts a smart phone displaying an example user interface in a rating view state of a content referral process.

FIG. 11 depicts a smart phone displaying an example user interface in a first action assignment view state of a content referral process.

FIG. 12 depicts a smart phone displaying an example user interface in a second action assignment view state of a content referral process.

FIG. 13 depicts a smart phone displaying an example user interface in a review view state of a content referral process.

FIG. 14 depicts an example content referral feed as it might be displayed on an electronic device, such as a smart phone or personal computer,

FIG. 15 depicts a smart phone displaying an example user interface in a recycle view state.

FIG. 16 depicts a smart phone displaying an example user interface in a content referral comment view state.

FIG. 17 depicts a representation of an example content referral database that may be utilized with the techniques described herein.

FIG. 18 depicts a representation of an example lists database that may be utilized with the techniques described herein.

FIG. 19 is a block diagram representing an example electronic device on which one or more portions of the present inventions may he implemented.

FIG. 20 is a block diagram depicting an example server operational environment in accordance with the techniques described herein.

FIG. 21 is a flow diagram that depicts an example methodological implementation for ranking for use in the techniques presented herein.

FIG. 22 is a flow diagram that depicts an example methodological implementation for search for use in the techniques presented herein.

### DETAILED DESCRIPTION

The technology described herein relates to user created content referrals that create searchable content. Information included on such user created content referrals provide a basis for an efficient search platform that users can use to quickly and easily find reliable search results, i.e., search results that are directly related to what users are searching for, such as products, places, businesses, people, etc. These techniques save users' time as well as computer and network resources in performing searches, since fewer searches are required to find relevant information and since the searched data set is smaller than a data set consisting of virtually everything on the Internet. Information from the content referrals and data related to the content referrals can be used to create databases of information. Because the contents of the searchable database are informed by identifiable users, a search of the database provides results that are more relevant to a user performing the search, and more reliable due to the searched information coming from a known source and/or trusted population of users. In addition, a user may limit a searched data set to one consisting of input from a single person (such as friend or a favorite celebrity) or a group of persons (typically a group of persons having at least one common characteristic, such as people in a certain geographic area, people of a certain age group, etc.).

Furthermore, users have at least partial control over ranking of subjects of user created content referrals for ranked lists (referred to herein as personal or global “lists” or “top ten lists,” although such lists are not limited to ten entries and may contain more or fewer than ten entries.) A scoring system is disclosed that is based, at least in part, on rankings provided by users and other user input, and scores are used to determine search results and create global “top ten” lists. Actions taken by users can be used to augment or diminish a score of a particular item (i.e., a subject of a content referral). Although implementations of various scoring systems may be used, any internal or external actions that can he taken by a user may be used to determine a score associated with a subject of a content referral. Examples of internal actions that can affect a score include, but are not limited to; a rating on a scale of ratings; a like; a recycle; a positive or negative comment; a thanks; a share; an action; an add to a list; a click; a request a list; a create a list; a request list update; a list update; visit a profile; votes; content funnels; a ranking; search; positive attributes (e.g., funny, aesthetic, innovative, talented, etc.); negative attributes (e.g., misleading, deceptive, fake, etc); and the like. Examples of external factors that can affect a score include, but are not limited to: creation of a user created content referral derived from a transaction; an external platform's analytics; an external platform's ratings/scorings/rankings; equities, products, services, real estate transactions; search results; conversion rate results; votes; content funnels; and the like.

Different types of lists may be used with the techniques described herein. Such lists include, but are not limited to, collaborative lists, poll lists, birthday wish lists, etc. Collaborative lists are a variant of personal lists where a creator can invite one or more other users to collaborate in the creation of a list. This means the other users can add and delete content referrals. Every user that collaborates by adding a content referral may receive an increase in score. The element created may also receive a score increase when added and its position may affect the score increase. A poll list is a list in which users can vote for an element they want to include in the list. At least two elements are needed to create a poll list, and the poll list may have a limited time frame in which votes may be accepted. A ranking is created according to a numbers of votes received by each element. The first element listed on a poll list is the one that garners the most votes, and so forth. Each user may receive a score increase for each vote. A birthday wish list is a personal list in which a user adds elements representing products the user would like for the user's birthday or other occasion. The user's followers can access a birthday wish list and acquire one or more of the products in the list, and those products will be sent to the user. Multiple users can collaborate to purchase a single product. The product and the user(s) may receive a score increase when the product is purchased, and the recipient of the product may also receive a score increase.

Also disclosed herein are techniques whereby a user can take a direct action on an item found in a search result. For example, if a user searches for a particular product or type of product, the search will likely return one or more products. Actions can be associated with the products, such as an action to navigate to a site to purchase a particular product. Or, for example, if a user searches for restaurants in a particular neighborhood or specializing in a particular type of food, an action may be available whereby the user can make a reservation at a restaurant returned in a search result, order delivery from the restaurant, etc. Other actions may also be included.

Generally, users begin with a basic content entry user interface (referred to herein as a “content referral”) to enter media content, a title for the content referral, one or more categories with which the content referral is associated, and one or more ratings associated with a thing, person, etc. By associating multiple categories with a content referral, a user can increase the chances that the content referral will be identified in a search. It is noted that one or more of the items listed above (media content, title, categories, rating) may be omitted from a content referral creation process. Different implementations may require more or fewer of these and similar items.

When a content referral has been composed, the content referral can be posted by a user to a user feed, which is viewable by user connections, an identified group of people, the general public, etc. Other users may comment on a content referral in the author's feed and can use content of the content referral to create their own referral with at least some elements of the content referral. When a content referral is created, a record corresponding to the content referral is created in one or more databases to preserve the entry. As contemplated herein, a content referral record is created in a searchable content referral database. Other types of records may be created in other types of databases depending on the implementation. In the examples described herein, a database of lists is maintained, and certain elements of a content referral—such as a description name and category—are stored therein.

Search results from searches performed within the systems described herein are more reliable than current search applications. For one, search aggregators can be prevented from manipulating the system, thus allowing directly relevant search results to be ranked at the top of a results list. Additionally, a user can search a subset of the general population that is deemed by the user to have a more relevant understanding of what the user is searching for, thus allowing the user to reach a reliable result more quickly (i.e. with fewer search operations). For example, a user may wish to limit a search for a local restaurant to people who actually live in a neighborhood, who might frequent local restaurants more than people who live outside the neighborhood. Or a user may wish to look at a top ten list for a particular celebrity the user follows, so as to get a recommendation from the celebrity.

Another feature described herein is a technique that allows a seller of a product to determine a source of a buyer's motivation to purchase the product or service, such as a person that referred the buyer to the product or service (or a seller of the product or service). A user can use a “thanks” feature to express appreciation to a person on whose recommendation they relied on to purchase or explore interest in a product or service. When the thanks function is activated, a content referral associated with the thanks may be stored in a user's (the “thanking” user's) personal wish list, where the user can easily access and perform subsequent actions on the product or service, such as purchasing the product or service. The thanks feature may also be used to give credit to a person who created original content used in a content referral.

By using the features of the systems and methods described herein, measurements can be made of the effects that peers' recommendations have on others. Sources of recommendations can be visualized with more accuracy than current social media analytics that only measure “engagement” actions between users, such as by way of a “like” feature or a “re-tweet.” Using the described technology, a thread between a first user's content referral (i.e. recommendation) and a second user's “thanks,” can be traced to identify a direct effect of the first user's referral on the second user's purchase. Further, influence of other users on the first user's recommendation can be identified. Once such relationships between user recommendations and purchases is identified, not only can sales from any given entity be identified as being related to a specific individual, but specific demographics and information as to how the products interact within an online social environment can be analyzed.

By being able to trace each succession of sales/experience to an identity of previous users, such influential users may be incentivized or rewarded, with money, discounts, and/or prizes. This can also serve to bring users and brands closer together, as the brands will be able to identify its most prolific “sales force” in a direct and reliable manner. Thus, sellers may be able to avoid intermediary fees typically paid to market their products by engaging directly with key influencers instead.

Currently, sellers measure effects among a user community in terms of “engagement,” However, “engagement” is more loosely defined in a digital media context, since measurements can only be made of interactions that do not relate to a relationship and commitment between sellers/brands and customers, as the term has historically been defined in the ad vertising/marketing industry. What digital content providers typically refer to as “engagement” now is related to action to click on certain links or “like” something. Neither of these actions truly says anything concrete to seller.

The measurement of direct cause and effect between a user recommendation and a purchase is concrete information that cannot be easily manipulated by those in a position to gain monetarily by manipulating the information. Media agency intermediaries can currently use the indefinite data regarding influencers to manipulate statistics to garner more income from sellers and advertisement media. Digital platforms can manipulate data through preferred placement of ads, search results, etc. Such manipulation can be drastically reduced or eliminated with use of the presently described techniques because sellers can receive accurate information directly from the market.

Even if a buyer does not use the “Thanks” feature, if a buyer buys a product directly from a content referral by using an “action” feature included on the content referral, a determination can be made as to what motivated the buyer to purchase the product. The “action” feature described in greater detail, below) allows the creator of a content referral to define certain actions that can be taken directly from the content referral, including an action to go directly to a seller and order the product. This feature allows more direct attribution of sales motivation than is currently found in other systems.

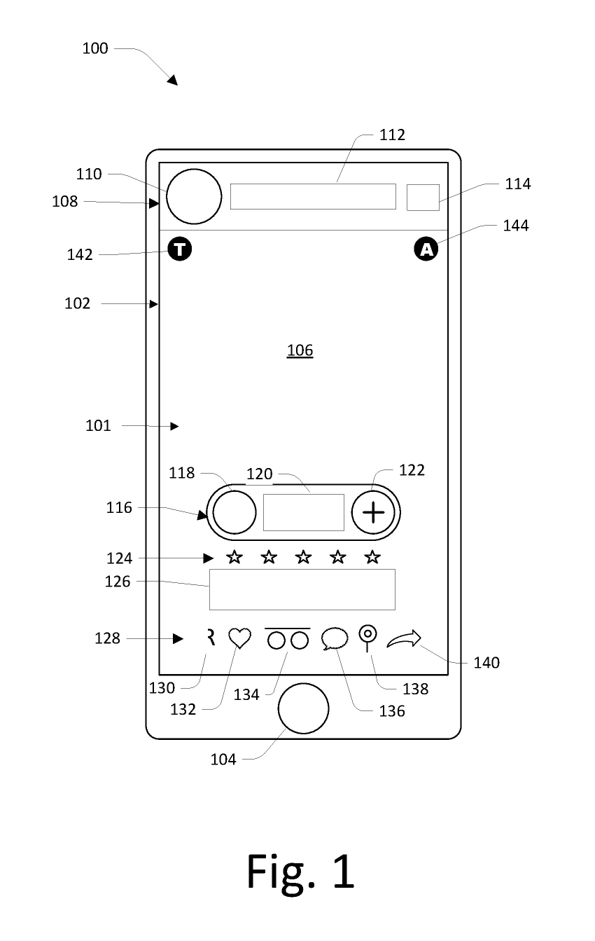

Other features and technological advancements of the systems and methods disclosed herein will be apparent from the present description and corresponding FIGS. 1-20.

### Content Referral Creation: User Interface

FIG. 1 is a representation of a smart phone 100 depicting an example user interface 101 that is used to create a content referral. The smart phone 100 includes a display 102 and a home button 104 similar to those commonly found in contemporary smart phones. The example user interface 101 includes an image field 106 on the display 102 where an image related to a subject of a content referral is displayed. The example user interface 101 also includes a title bar 108 that displays certain information related to the content slide, such as a personal icon 110, a user name 112, and a score 114. The personal icon 110 may consist of a photograph of a user associated with the content slide, an avatar, a logo, or the like. The user name 112 may consist of a user's real name or alias, or an entity identifier, such as a company name, team name, etc. The score 114 (described in greater detail below) is an indicator of how certain actions or potential actions conducted via the user interface 101 will affect a metric used to rank aspects of elements shown in the example user interface 101.

In at least one implementation, a user having met certain criteria may be identified as a “power user” or something similar that indicates a specific characteristic of a user. Such user identifications may have multiple levels and can be based on information related to the user, such as how many content referrals the user has created, how many verified purchases a user has made, how many likes, thanks, favorites, forwards, etc. that the user has made with respect to other users' content referrals, or how many likes, thanks, favorites, forwards, etc. the user has received in content referrals, lists, interactions, etc. created by the user. If a user has attained such a designation, then the designation may be displayed in association with the user, such as in the title bar 108 or, more particularly, in the personal icon 110. Such a designation may also affect other aspects of the content referral system. For instance, scoring associated with a “power” user may be weighted to give more credence to that user's opinion.

In at least one implementation, a user having met certain criteria may be identified as an “expert user.” An expert user is a user that has expertise in one or more subjects. A determination as to who qualifies as an expert may be done automatically or manually. Such a determination can be made by analysis of subject of the user's content referrals, by other users' interactions with the creating user's content referrals (e.g., requesting lists, requesting list updates, making purchases from the user's content referrals, sending thanks with respect to the user's content referral(s), user interactions with associated categories to the user's expertise; from the user's professional credentials, etc. and/or from the user's external interactions, scoring, ratings in other platforms, transactions, content funnels (time spent by users creating, viewing, interacting, searching content referrals and lists) etc. A visual indication of the status of a user as an expert may be displayed in the user's profile, in content referrals and lists created by the user, so as to let viewers know that the information contained in a content referral may be trusted more than it might be if no such indication is present.

Other special designations for users may be implemented in addition to or instead of the designations mentioned above. For example, some such designations are “guardian user” and “research user.” A “guardian user” is a user that performs a significant amount of actions that relate to helping other users comprehend an appropriate meaning of a content referral or element thereof, by adding disambiguation text, identifying misinterpreted content referrals in wrong categories, etc. A “guardian user” may also be a user that reports vandalism, bullying, or other such unacceptable actions. A “research user” designation identifies a user that provides research on various topics and create content referrals that include research data (e.g., scientific, encyclopedic, cultural, historical, etc.) that benefits a community of users.

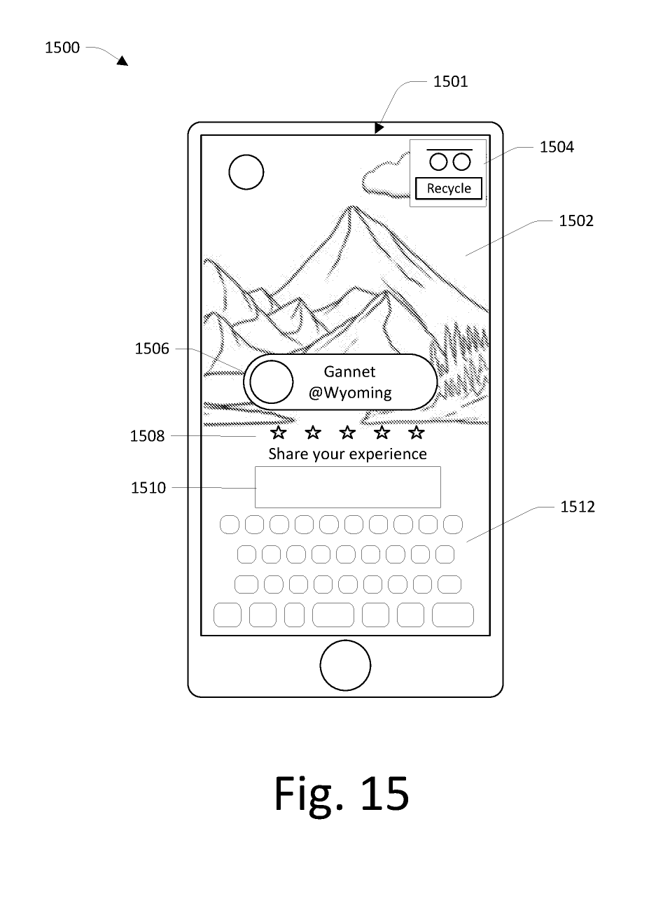

Another component of the example user interface 101 is a descriptor bar 116, which can contain various elements related to a subject of the content referral shown in the example user interface 101. In the present example, the descriptor bar 116 includes an image icon 118, a description field 120, and an addition icon 122. Although the descriptor bar 116 is shown in the present example as having a. limited number of components, one or more alternative implementations may utilize more or fewer components than those shown and described herein. The image icon 118 is a visual representation that may be related to a subject matter of a content referral being created using the example user interface 101, such as a smaller version of a photo shown in the image field 106, text related to content shown in the example user interface 101, or the like. The image icon 118 may also be unrelated to the subject matter of the content referral, such as in a case where the subject matter is an audio recording and the image icon 118 may simply be an image that indicates the presence of an audio recording. The description field 120 is configured to display a description of content shown in the example user interface 101. Such a description may vary by implementation, and at least one variation implements a description the format of “subject@category,” wherein “subject” describes a subject of a content referral (such as a product, place, person, etc.) and “category” is a user-selected category of subjects (such as jeans, restaurants, Lady Gaga, etc.). A character may be used to separate the subject and category denotations, such as the “@” character used in this particular example. Further details of the description are shown in FIG. 15, below, and described in relation thereto. Finally, the addition icon 122 of the descriptor bar 116 is an actuatable control that is configured to add a content referral created from the example user interface 101 to one or more lists. This feature and the concepts and roles of lists are described in greater detail below.

The example user interface 100 also includes a rating input mechanism 124, a review dialog box 126, and multiple widget icons 128. The rating input mechanism 124 can be any such function that is capable of allowing a user to input a score from a range of scores, said score indicating a user's favorability rating, or sentiment, toward the subject matter of a content referral created by way of the example user interface 101. In the present example, a user may assign a rating of from one star to five stars. Alternative implementations may include a different variation of a rating input function, such as an assigning of a numerical value within a range such as one to ten, thumbs up and down, emoticons, etc. The review dialog box 126 is configured to accept input from a user that is not limited to any particular range of acceptable inputs, such as a text entry containing ASCII characters.

The widget icons 128 can be any number of icons configured to perform virtually any electronically-based task. In the present example, the widget icons 128 include an attributes icon 130, a like icon 132, a recycle icon 134, a comment icon 136, a thanks icon 138, and a forward icon 140. The attributes icon 130 displays a set of attributes that describe positive and/or negative characteristics of a content referral. For example, if a viewing user thinks that a content referral is aesthetically pleasing, the user may use the attributes icon 130 to express that feeling. The user may express other subjective attributes of the content referral, such as whether the user thinks the content referral is funny, innovative, misleading, deceptive, fake news, etc. The user may also use the attributes icon 130 to express the user's feeling that the person who created the content eferral is talented, etc. Through use of the attributes icon 130, users can evaluate a creator's content. User entries by way of the attributes icon 130 may increase a score associated with a subject of a content referral if the assigned attribute is positive, or they may decrease such a score, if the assigned attribute is negative score. Distinguishable from the attributes icon 130 is the like icon 132. The like icon 132 is similar to like icons found in other platforms. When a user actuates the like icon 132, it is a way for the user to indicate that the user likes something in particular with the content referral displayed with the like icon 132. However, the like icon function is a more ambiguous appreciation for the content referral as a whole, as it cannot be determined what it is about the content referral that the user likes—the content referral as a whole, the user who created the content referral, an image included in the content referral, etc. As regards to scoring, the specific appreciations indicated by use of the attributes icon 130 may receive more weight than the general appreciations shown by use of the like icon 132.

The recycle icon 134 may be actuated by a user when the user wants to create a new content referral based on an existing content referral, i.e., the user “recycles” one or more components of the content referral. The comment icon 136 is actuated by a user when the user wants to enter a comment to be associated with a content referral. The thanks icon 138 may be actuated by a user when the user wants to identify the source of a referral that will lead to or has led to an action on a product, place, business, etc. The forward icon 140, when actuated by a user, forwards the content referral to another user as a link or code of the native platform to one or more external platforms such as social media platforms, messaging platforms, email platforms, etc. This may also be used to enable people to purchase a product or service or perform a different action related to the content referral. The function of the forward icon 140 enables capitalization of sharing of content from the native platform while continuing to track and generate data. It is noted that a scoring system used to score and rank content referrals may associate a score with any action taken with the aforementioned icons. For example, a score for a restaurant may be increased when a user actuates the like icon 132 in a content referral interface having the restaurant as its subject.

One or more of the widget icons 128 may be actuatable from the example user interface 101, but one or more of the widget icons 128 may be inoperable, at least in the present example user interface 101. In the present example, for instance, the comment icon 136 may not be operable with the example user interface 101, but may be present to show a complete view of a content referral that is created by way of the example user interface 101. This way, a user can more completely see what a content referral will look like as the user is creating it using the example user interface 101. In at least one alternative implementation, action icons that are not actuatable in a particular user interface are not displayed in that particular user interface.

The example user interface 101 also includes a top ten icon 142 and an action icon 144. A user may actuate the top ten icon 142 to view all categories that a content referral creator assigns to a content referral. For example, if a subject of the content referral is “Gannett Peak,” then additional categories added by the creator may include “Wyoming,” “Mountains,” “Hiking,” etc. The user may select one of the displayed categories to view a list associated with each category. In at least one implementation, a user can add an additional category and/or a list (personal top ten, global top ten, ranked list, favorites, etc.) by way of the top ten icon 142. The action icon 144 is actuatable by a user to select an action to associate with the content referral created by way of the example user interface 101. The function of both the top ten icon 142 and the action icon 144 are described in greater detail below, with respect to the subsequent figures.

### Content Referral Creation: User Interface

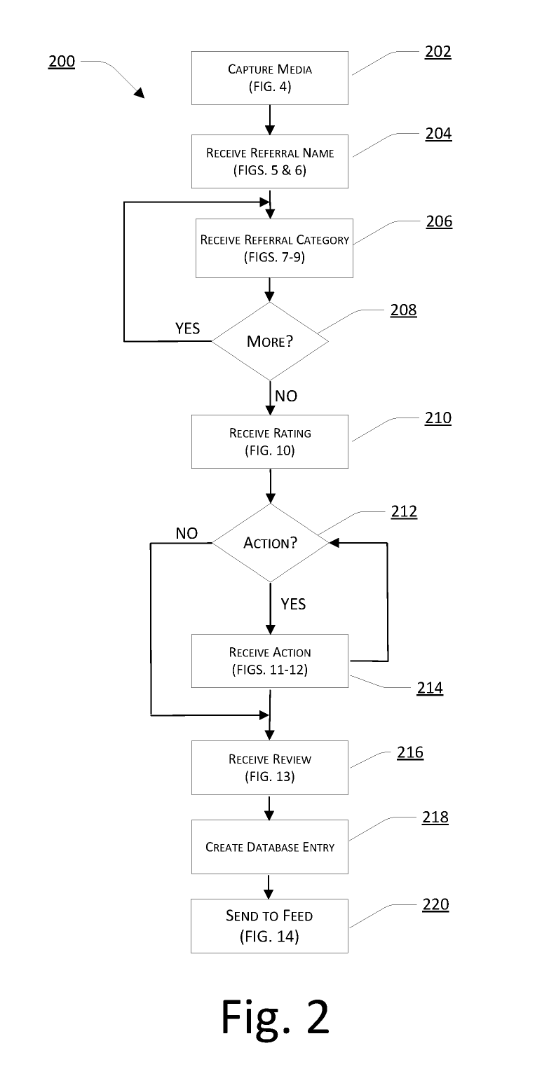

FIG. 2 is a flow diagram 200 that depicts an example methodological implementation for creation of a content referral for use in the techniques presented herein. In the following discussion of the flow diagram 200, continuing reference may be made to the element names and/or reference numerals shown in FIG. 1. The basic steps included in creating a content referral are described with respect to the flow diagram, and further details of each step are shown in and described with respect to subsequent figures, as noted in FIG. 2. It is noted that although particular steps are described in the following discussion of the flow diagram 200, more or fewer steps may be included in an alternative methodological implementation. Furthermore, two or more discrete steps shown in and described with respect to the flow diagram 200 may be combined into a single step in a logical implementation of one or more of the techniques described herein.

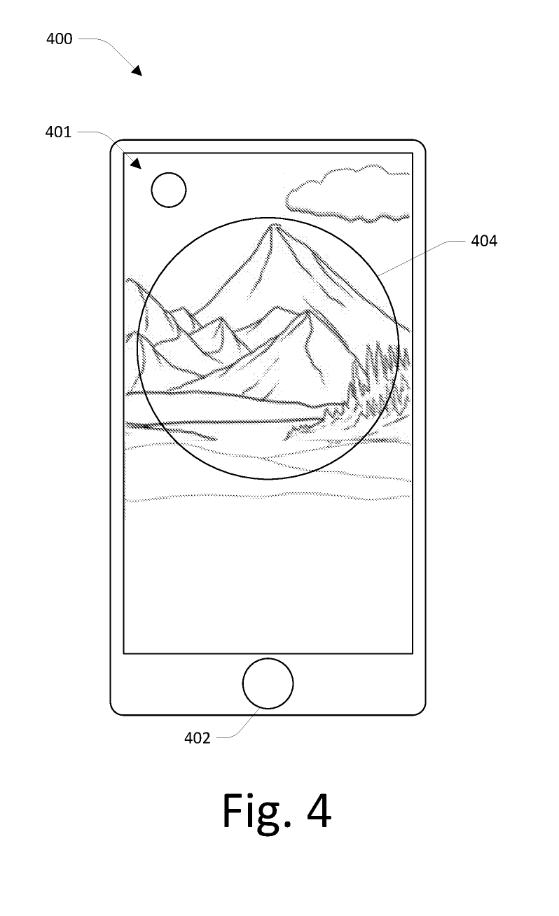

At step 202, a user captures media to be included in a content referral the user is creating. Captured media can be any type of media collected by any media capture method known in the art, such as a digital image (still or motion) captured by a digital camera or retrieved from an electronic storage location, a digital audio clip captured by a microphone or retrieved from an electronic storage location, or the like. Media capture is described in greater detail below, with respect to FIG. 4.

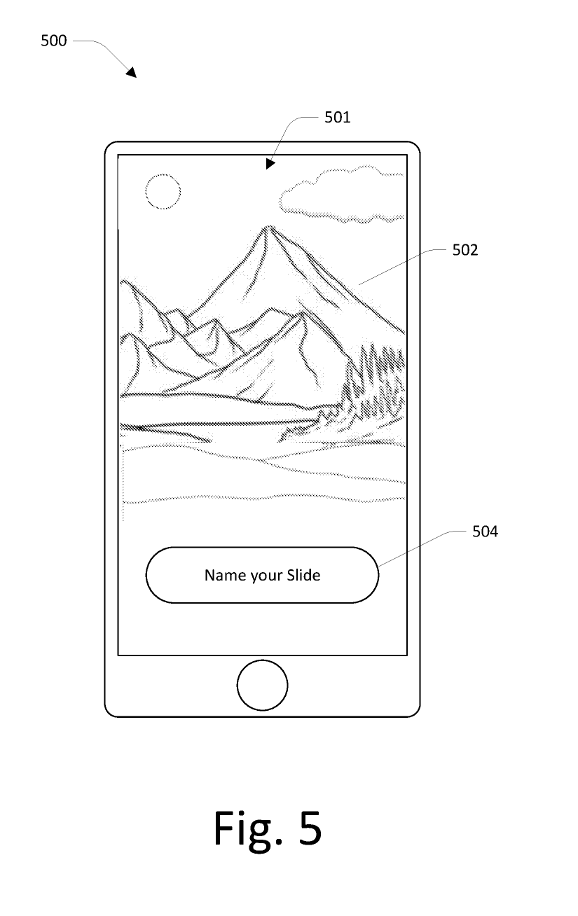

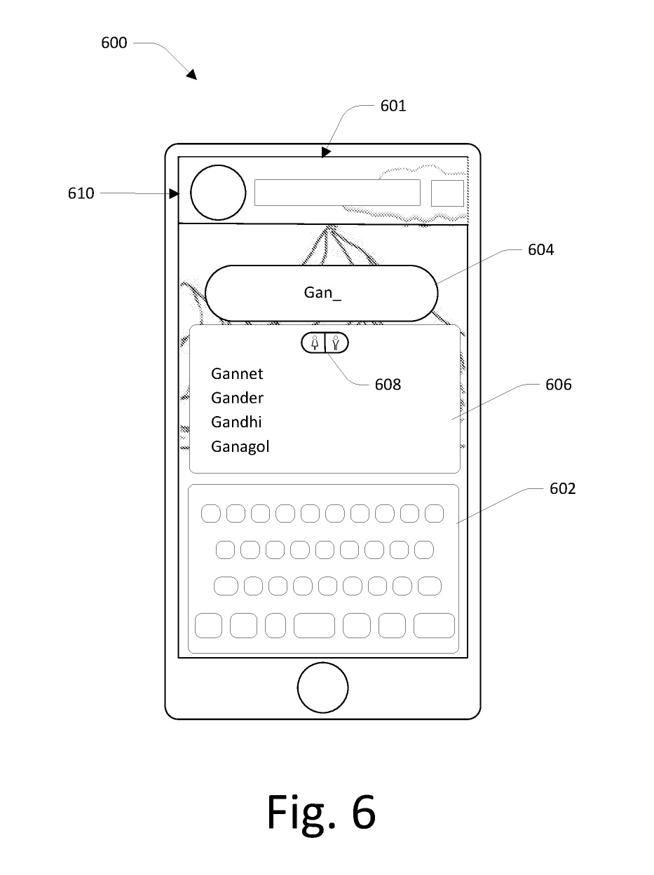

At step 204, a user names the content referral being created by entering a description of the content referral in the description field 120. In one or more implementations, such a description may merely be a text string that has no other function. However, as in the techniques described herein, a user may be required or encouraged to enter a description in a particular format that denotes certain functionality. More details about naming a content referral are disclosed below, with respect to FIG. 5 and FIG. 6.

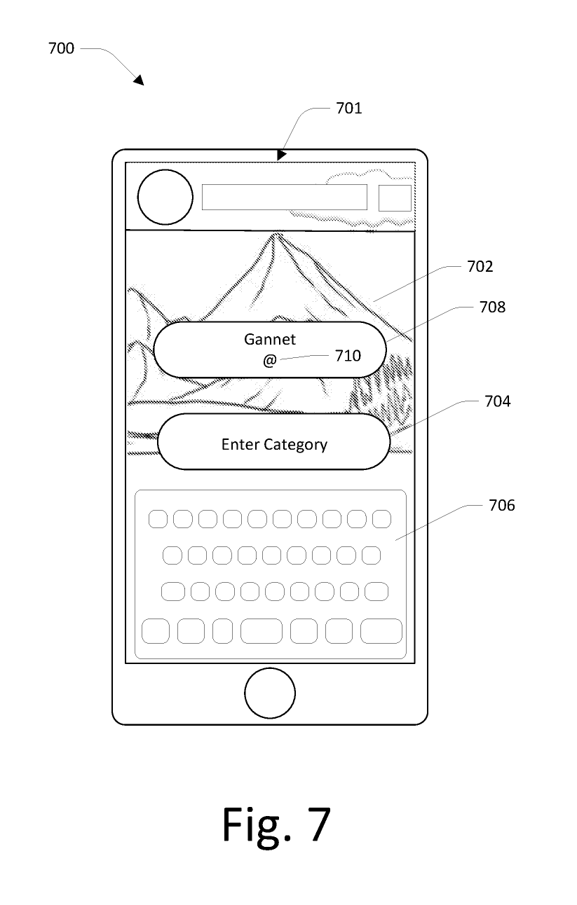

At step 206, a user indicates a category description that identifies a category with which the content referral will be associated. For example, if a subject matter of a content referral being created by way of the example user interface 101 is a purse a product). then the category description may be “purses.” More than one category may be assigned to a content referral. If after a first category is entered, a user wishes to enter a subsequent category (“Yes” branch, step 208). If so, then the process reverts to step 206, where an additional category is entered. In the previous example wherein the subject matter of a content referral is a purse, a user may enter a designer of the purse or a seller of the purse to a category (i.e., “Designers,” or “Sellers,” etc.) to which the user wishes to associate the newly-created content referral. When the user has finished entering categories (“No” branch, step 208), the process continues at step 210. More on assigning categories to content referrals is discussed below, with respect to FIGS. 7-9.

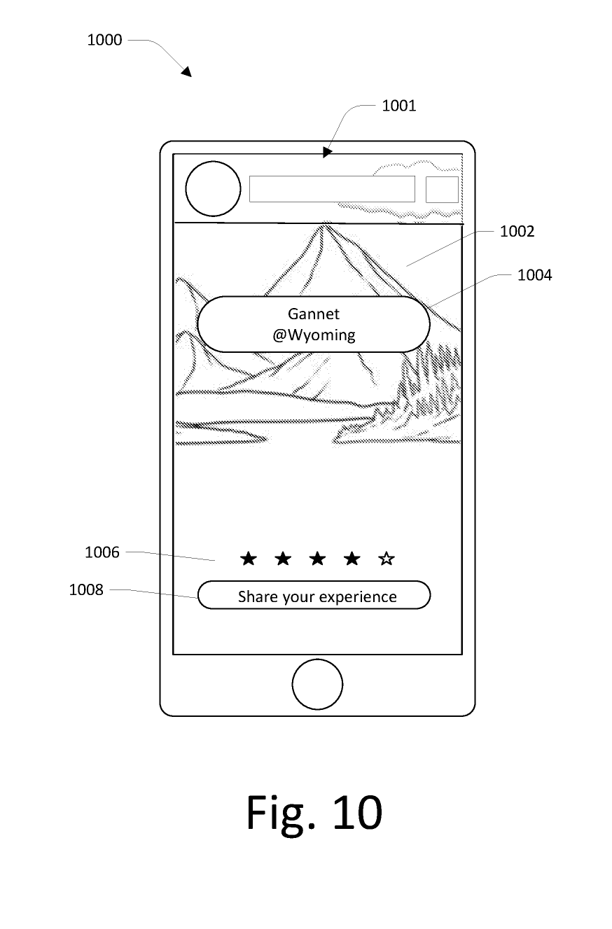

At step 210, a user enters a rating to be associated with a content referral being created using the example user interface 101. In particular, the user enters a rating via the rating input mechanisms 124 of the example user interface 101. In the example presented herein, the user selects from one to five stars that serve as a rating of the user's disposition toward a subject of the content referral being created. Further details of the rating input mechanism are shown in FIG. 10 and described with respect thereto, below.

At step 212, a user may associate an action with a content referral that the user is creating via the example user interface 101. The term “action” as used herein refers to an event or series of events that occur when a user selects an icon that is associated with an action. Examples of actions include, browse or purchase a product, make a reservation, save the date, donate to a fund-raising campaign, place an order, etc. When a content referral is viewed (i.e. after it is created), the action icon 144 may be actuated to perform a single action, or a drop-down menu of multiple actions may appear upon actuation of the action icon 144, depending on the implementation. Relative to step 212, assigning one or more actions at the creation of a content referral is described.

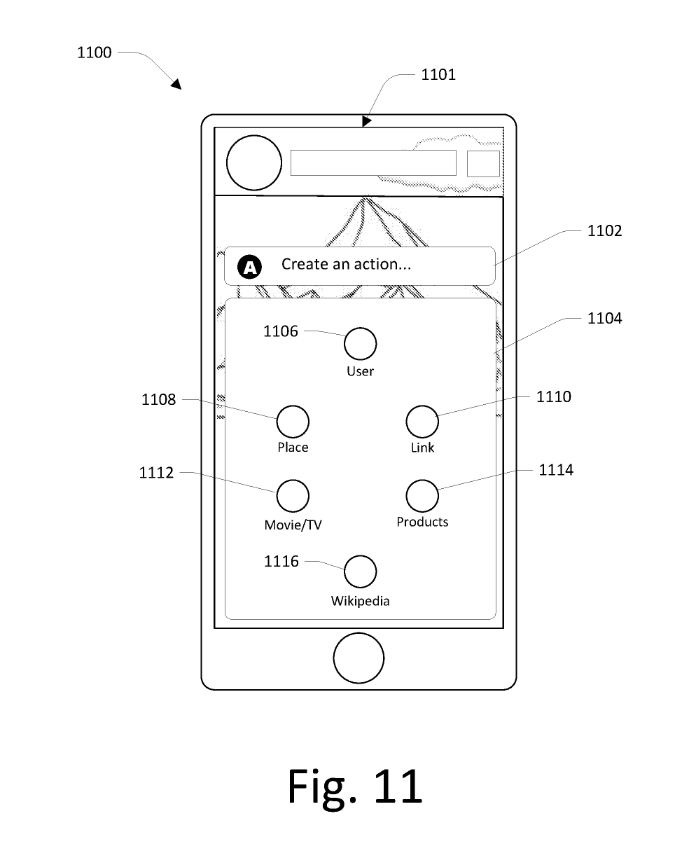

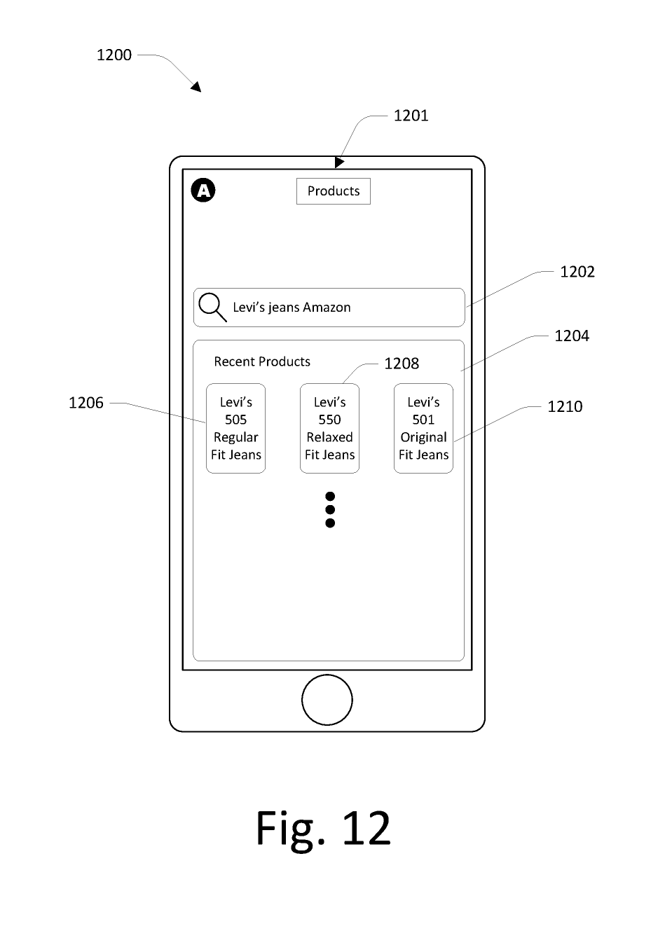

If a user does not want to associate an action with a content referral being created (“No” branch, block 212), then no action is assigned and the process continues at step 216. If a user wants to associate an action with an under-construction content referral (“Yes” branch, step 212), then the user clicks on the action icon 144 and is presented with a menu or a page offering one or more choices of actions that can be assigned to the action icon 144. An example of one implementation for doing this is shown below, with reference to FIGS. 11-12. If additional actions are to be assigned to the action icon 144 or a derivative thereof, then the process reverts to step 212 until no more actions need to be assigned. At that point, the process continues at step 216.

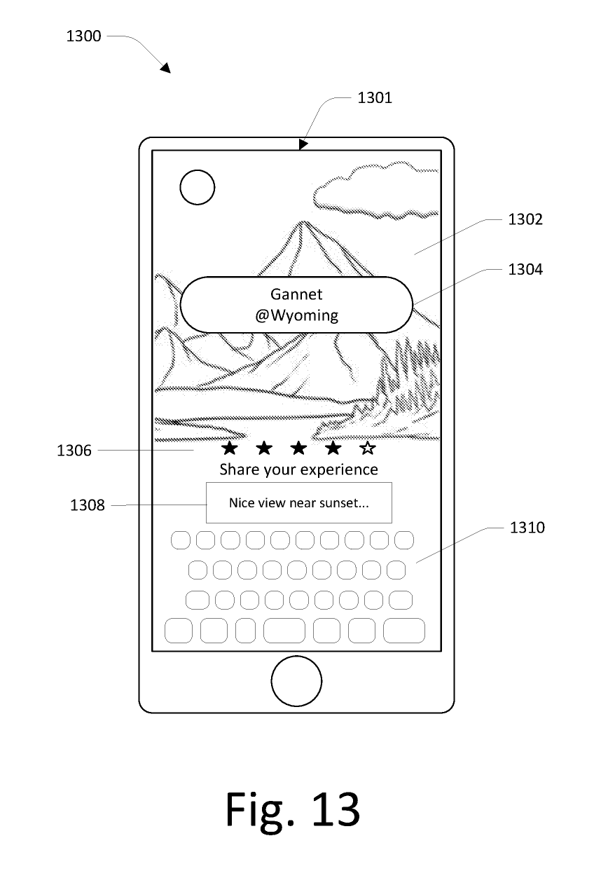

At step 216, a user enters a. review into the review dialog box 126 of the example user interface 101. The review can be any ASCII character, such as text or symbol, or an emoji or other indication of a user's opinion. One way to put it is that this allows a user to enter his own comment regarding the subject matter of a content referral that the user is creating. Details of the process and interface for entering a user review is shown in and described with respect to FIG. 13.

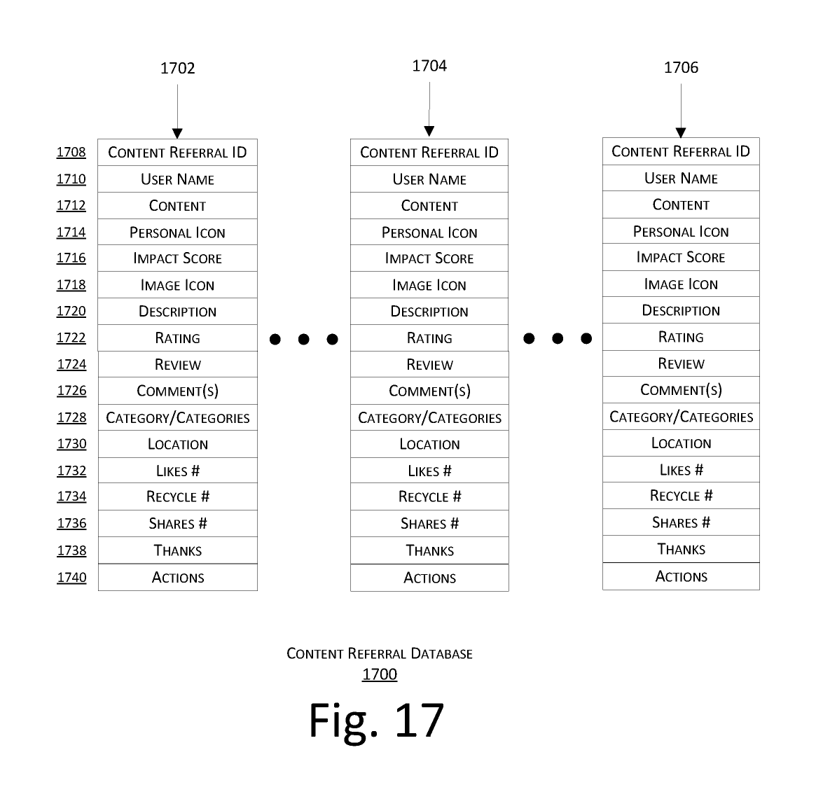

At step 218, the information entered into the example user interface 101 is stored in a database record, an object, or any other data structure known in the art. An example of a database for storing such information is shown in and described with respect to FIG. 17, below. At this point, the newly-created content referral containing information received via the example user interface 101, can be stored, transmitted, manipulated, etc., as a digital entity.

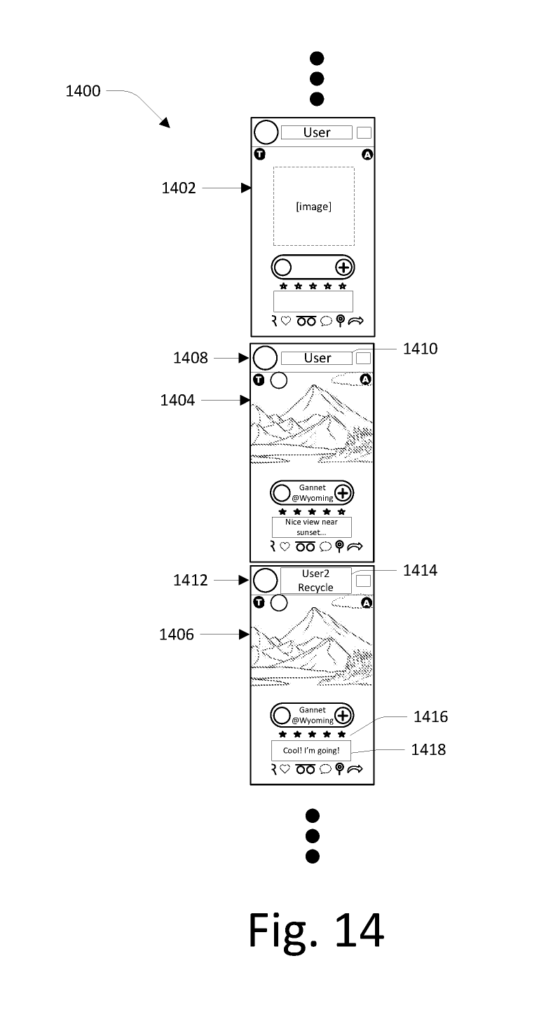

At block 220, the newly-created content referral is posted to a user feed or to a different location, depending on the particular implementation. Once posted, users other than the user that created the content referral can take particular actions related to the content feed, many of which are described below. An example feed containing multiple content referrals is shown in and described below, with respect to FIG. 14.

### Content Referral Creation—Basic View

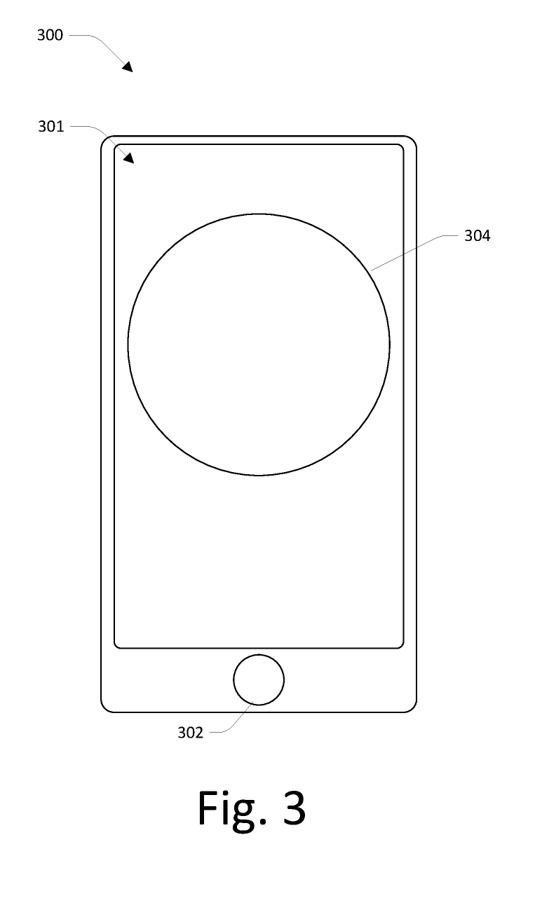

FIG. 3 is a representation of an example smart phone 300 displaying an example base view user interface 301 in accordance with the techniques described herein. The example base view user interface 301 is a view of an initial state of a content referral user interface used in the disclosed techniques and previously shown in and described with respect to FIG. 1. In the following discussion, continuing reference is made to elements and reference numerals shown in previous figures.

The example smart phone 300 includes a home button 302 that may be used to capture an image. In one or more alternate implementations, a phone may not include a hardware button similar to the home button 302. In those cases, or in cases where an implementor decides not to use a hardware button for the purposes described below, an actuatable capture button may be implemented in software and displayed on the example base view user interface 301. The example base view user interface 301 includes a focus ring 304, The focus ring 304 may be used with a smart phone camera (not shown) to indicate the center focus of an imaged object, such as a person, a mountain, a store, a product, etc. In at least one implementation, the portion of an image that appears in the focus ring 304 is used as the image icon 118 of the descriptor bar 116. The image in the focus ring 304 may also be used for other purposes. When a user has positioned the smart phone 300 so the image the user desires to take appears in the focus ring 304, the user captures the image by pressing the home button 302 or some other hardware button or software icon. Although no other graphics are shown on the example base view user interface 301, it is noted that one or more of the elements shown in the example user interface 101 (FIG. I) may also appear. The present figure and discussion is limited to particular elements involved in capturing an image.

Content other than an image may also be captured for use in a content referral. For example, pressing the home button 302 or a video icon (not shown) may start a video capture process that associates a digital video with a content referral. Or pressing the home button 302 or an audio icon (not shown) may start an audio recording that can be associated with a content referral. Any method known in the art for capturing content may be used with the techniques described herein.

### Content Referral Creation—Capture View

FIG. 4 depicts a smart phone 400 displaying an example user interface 401 similar to the example user interface 301 shown in FIG. 3, but in a capture view state of a content referral creation process. The smart phone 400 includes a home button 402 that can be actuated to perform various functions, although many of the same functions may be implemented using a soft button (not shown). The example user interface 401 is shown displaying an image 404 sensed by way of a smart phone camera (not shown) or downloaded from an image source external to the smart phone 400. In this particular example, an image of Gannet Peak, a mountain located in the United States state of Wyo. The example user interface 401 also includes a focus ring 406 that surrounds at least a portion of the image 404. The focus ring 406 informs a user of a portion of the image 404 that will be used in other applications, such as to represent the image icon 118 (FIG. 1) of the descriptor bar 116. When the user has obtained the desired view, the user captures the image 404 by actuating the home button 402. The image 404 can then form the basis for a content referral.

Content Referral creation First Naming View

FIG. 5 depicts a smart phone displaying an example user interface 501 similar to the example user interface 401 shown in FIG. 4, but in a first naming view state of a content referral creation process. The example user interface 501 displays air Image 502 captured in a previous step of the content referral creation process. In the first naming view state shown, the example user interface 501 includes a dialog box 504 wherein a user is directed to enter a name for the content referral under creation. When a user desires to begin naming the content referral being created, the user actuates the dialog box 504 (by, for example, tapping the dialog box 504). In one or more alternate implementations, a soft keyboard may appear in the example user interface 501 to immediately allow the user to enter a name for the content referral.

### Content Referral Creation—Second Naming View

FIG. 6 depicts a smart phone 600 displaying an example user interface 601 similar to the example user interface 501 shown in FIG. 5, but in a second naming view state of a content referral process. The example user interface 601 includes a soft keyboard 602 that appears after a user actuates the dialog box 504 (FIG. 5). The soft keyboard 602 provide a method for the user to enter a name for a content referral that the user is creating. However, other input methods may be used for this purpose, including a speech interface. The example user interface 602 also include a dialog box 604 that shows the characters entered by the user as the user types the characters on the soft keyboard 602. The example user interface 601 also includes a suggestion box 606 that lists suggestions to complete the user's entry (i.e., auto-complete). As the user types, more exact inferences can be made for the suggestions. In the present example, the letters “Gan” have been entered into the dialog box 604, which has resulted in suggestions of “Gannet,” “Gander,” “Gandhi,” and “Ganagol.” In the present example, the user intends to enter “Gannet” in the dialog box 606 to name the content referral being created after the name of the mountain shown in the image.

The suggestion box 606 is also shown including a gender identifier icon 608, which may or may not be included in particular implementations. Particularly with regard to some products, such as clothing, it may be important to identify the product as being particularly suited to a man or a woman. The gender identifier icon 608 provides a way to indicate that a pair of jeans, for example, are women's jeans and not men's jeans. The default gender identification is neutral and only changes if a male or female gender identification is selected. Additionally, the example user interface 601 may show other elements, such as a title bar 610 (similar to the title bar 108 shown in FIG. 1). Such additional elements may be active or may simply be displayed to give the user an idea of how the completed content referral will appear.

### Content Referral Creation—First Category ID View

FIG. 7 depicts a smart phone 700 displaying an example user interface 701 similar to the example user interface 601 shown in FIG. 6. but in a first category identification view state of a content referral process. The example user interface 701 displays an image 702, a first dialog box 704, a soft keyboard 706. and a second dialog box 708. After a user has entered a name for a content referral (as in FIG. 6), the user is prompted to enter a category with which the user's content referral will be associated. The user may associate a content referral with more than one category, but at least one category will be identified. In the example user interface 701, the first dialog box 704 displays an instruction for the user to enter a category. The soft keyboard 706 provide an input method for the user to enter a category with which to associate the user's content referral. The second dialog box 708 shows the name for the content referral that was previously entered by the user followed by a linking symbol 710. In the presently described techniques, a content referral is associated with a text string that includes a name and a category for a content referral. The name and the category are linked by a linking symbol (the “at” symbol—“@”—in the particular implementation shown, but any other character may be used in the same manner). When a user encounters the prompt shown in the example user interface 701, the user can begin to enter a category name, as described further, below. It is also noted that the name of the content referral may also act as a category in one or more implementations. For example, a content referral subject may relate Jennifer Aniston in her role on “Friends,” and the content referral may be named JenniferAniston@Friends. In such a case, the name “JenniferAniston”—may also be a category, and “Friends” is a category.

### Content Referral Creation—Second Category ID View

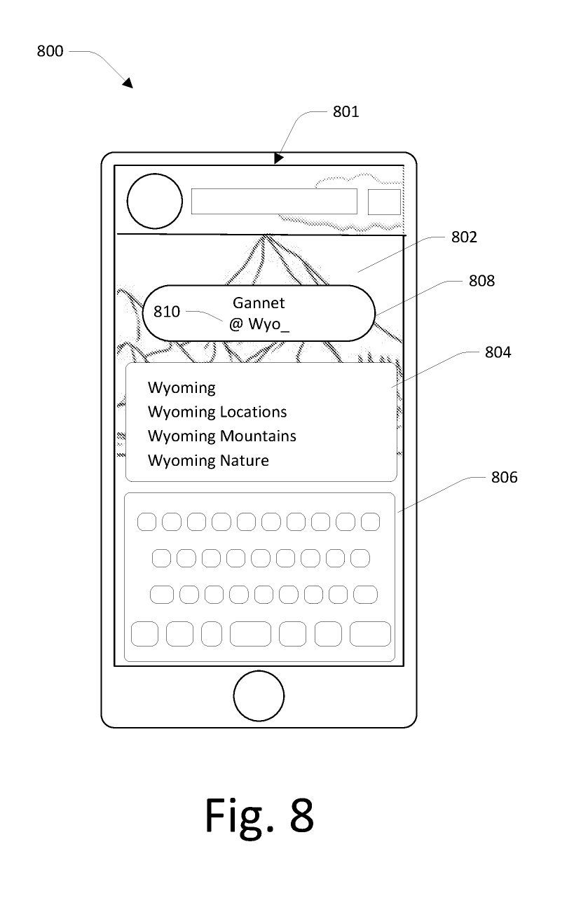

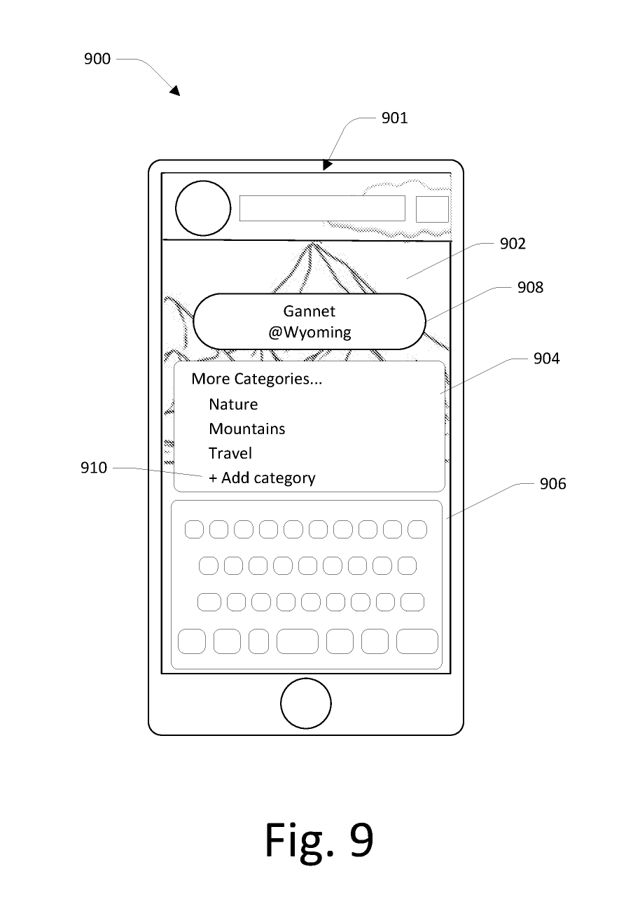

FIG. 8 depicts a smart phone 800 displaying an example user interface 801 similar to the example user interface 701 shown in FIG. 7, but in a second category identification view state of a content referral process. The example user interface 801 includes an image 802, a first dialog box 804, a soft keyboard 806, and a second dialog box 808. As a user enters a category name on the soft keyboard 806, the characters typed by the user appear after a linking symbol 810 that follows a name already provided by the user. As the user enters characters, inferred complete words and/or terms are displayed in the first dialog box 804 to provide a shortcut for the user to enter the category name, In the present example, the s wishes to enter “Wyoming” as a category, so the user can either finish typing “Wyoming” or the user can select “Wyoming” from the list of suggested categories shown in the first dialog box 804. Once that operation is completed, the example user interface 801 appears as shown below, with respect to FIG. 9.

### Content Referral Creation—Third Category ID View

FIG. 9 depicts a smart phone 900 displaying an example user interface 901 similar to the example user interface 801 shown in FIG. 8, but in a third category identification view state of a content referral process. The example user nterface 901 includes an image 902, a first dialog box 904, a soft keyboard 906, and a second dialog box 908. At this point in the process, a user has entered a name and a category with which to associate the content referral that the user is in the process of creating. By way of the example user interface 901, the user has an opportunity to associate the content referral that is under creation and the name of the content referral (“Gannet” in the present example, as shown in the second dialog box 908), with a different category. Oftentimes, a user may wish to associate his content referral with more than one category, so that the content referral may be found in a search of more than one category. For instance, if the subject matter of a content referral is a purse, a user may wish to associate the content referral with the category “purse” (which would allow the content referral to found in a search of the category “purse”) and with a category of a designer of the purse (e.g., “Chanel”). Adding the content referral to a “Chanel” category allows the content referral to be found in a search of the “Chanel” category. In addition to adding to a searchable dataset, assigning a category to a content referral may also have other effects, such as enabling a Chanel purse to be compared with other similar or different products in additional categories.

Additional categories may be suggested in the first dialog box 904. In the present example, suggestions appearing in the first dialog box 904 are “Nature,” “Mountains,” and “Travel.” An “+Add Category” button 910 is also included to allow the user to enter a new category that is not in the suggested list of categories. Actuation of the “+Add Category” button 910 reverts the user to the example user interface 801 shown in FIG. 8, and the process for adding a category is repeated.

### Content Referral Creation Rating View

FIG. 10 depicts a smart phone 1000 displaying an example user interface 1001 similar to the example user interface 901 shown in FIG. 9, but in a rating view state of a content referral process. When a user has completed entering a name and category for a content referral that the user is creating, the example user interface 1001 provides an opportunity for the user to assign a rating to the content referral being created. In one particular implementation, the example user interface 1001 includes an image 1002, a dialog box 1004, and a rating mechanism 1006. The dialog box 1004 displays the name and a category associated with the content referral being created. If there are more than one categories associated with the content referral and the name of the content referral, the first category assigned to the name and content referral is displayed. Other categories are shown when the top ten icon 142 (FIG. 1) is actuated, and a user can select and access each of the categories to interact with the ranked content. However, this may vary in one or more alternate implementations.

The rating mechanism 1006 shown in the example user interface 1001 is based on a five-star rating system (or a similar rating system, e.g., thumbs up down, emojis, slider(s), etc.) wherein a user can assign a rating from one to five stars to the subject matter of the content referral that is being created. Typically, the smart phone 1000 will include a touch screen, so a user can simply select the appropriate star to match the rating that the user wants to assign to the content referral. Other mechanisms known in the art may be used, such as assigning a number rating from one to ten, etc. An instruction box 1008 is also shown included with the example user interface 1001, though it is not required.

### Content Referral Creation—First Action Assignment View

FIG. 11 depicts a smart phone 1100 displaying an example user interface 1101 similar to the example user interface 1001 shown in FIG. 10, but in a first action assignment view state of a content referral process. The example user interface 1101 includes a first dialog box 1102 and a second dialog box 1104. After a user has entered a rating for a content referral the user is creating, the user is provided an opportunity to associate one or more action items to the content referral. An action item is an action that is taken upon selection by a user, the action being related to the subject matter of a content referral. As previously discussed, when a user selects the action icon 144 (FIG. 1), the user is presented with one or more actions that the user can take. The example user interface 1101 is where a user that creates the content referral identifies which actions can be taken by another user when the other user selects the action icon 144 (FIG. 1).

The first dialog box 1102 of the example user interface 1101 invites a user to create an action to associate with the user's content referral that the user is in the process of creating. The second dialog box 1104 presents one or more actions that the user can select to add a particular action to the user's content referral. The actions shown in the present example are: a User action 1106, a Place/Location action 1108, a Link action 1110, a Movie/TV action 1112, a Products action 1114, and a Wikipedia® action 1116. These actions are representative only, and other types of actions may also be implemented. The user may select one or more of the actions shown and, when an action is selected, that action will he available from the content referral. In one or more alternate implementations, actions may be associated with a content referral, either manually or automatically. For example, if a content referral is automatically created from a product on a vendor site, a link action (i.e. a live link) may be added to the content referral so that a user viewing the content referral can activate the link to navigate to the product page on the vendor site, It is also noted that links can appear in content referrals shown in a user feed, so that a viewer of the feed can actuate a link to navigate directly from the feed view.

The User action 1106 is an action that adds a user profile to an action and is used to go directly to a user profile, where another action may be performed, such as acquiring a coupon, contacting the user associated with the user profile, etc. The Place/Location action 1108 enables a user to open a specified location in a mapping, GPS, or location platform. The Place/Location action 1108 can also be used to add information about the specified place, to dial a telephone number specified in the action, etc. The Link action 1110 follows a custom link that is input by the content referral creator after selection of the Link action 1110. The Movie/TV action 1112 is a link that, upon selection, takes a user to one or more movies or television shows that is related to the subject matter of the content referral. For example, if the subject of the content referral is actress “Jennifer Aniston,” selection of the action icon 144 (FIG. 1) may take the user filmography of Jennifer Aniston and/or a site where a user can rent or purchase movies or television shows featuring Jennifer Aniston. The Products action 1114 is a link to one or more sites that display one or more products associated with the subject matter of a content referral. For instance, if the subject of a content referral is “Vera Wang,” then a Products link 1114 may take a user to a site where the user can browse and/or purchase “Vera Wang” products. The Wikipedia® action 1116 is a link that takes a use to a Wikipedia® article on the subject of the content referral.

When selling up actions to be associated with a content referral, subsequent steps may need to be taken to complete the link to the appropriate destination. The following example discusses how an action association might be completed using the Products link 1114 as an example.

### Content Referral Creation—Second Action Assignment View

FIG. 12 depicts a smart phone 1200 displaying an example user interface 1201 similar to the example user interface 1101 shown in FIG. 11, but in a second action assignment view state of a content referral process. As previously noted, the example user interface 1201 is displayed when a user selects the Products link 1114 in the example user interface 1101 of FIG. 11. The example user interface 1201 includes a search box 1202 and a products display box 1204. When a user enters a product and/or seller in the search box 1202, one or more products are shown in the products display box 1204, any of which a user may select to be linked to when a user selects the Products link 1114 (FIG. 11).

In the present example, a content referral is related to Levi's jeans (possibly because the creator just purchased some of the jeans and is giving a recommendation about the jeans or where to buy the jeans, etc.). The search terms “Levi's,” “jeans,” and “Amazon” are entered in the search box. As a result of the search using those search terms, several products are displayed in the products display box 1204.

A first product icon 1206 displays a link to “Levi's 505 Regular Fit Jeans” on Amazon®. A second product icon 1208 displays a link to “Levi's 550 Relaxes Fit Jeans” on Amazon®. A third product icon 1210 displays a link to “Levi's 501 Original Fit Jeans” on Amazon®. In some cases, more or fewer products will be displayed. When one of the product icons (1206, 1208, 1210) is selected, then selecting an action from the content referral will take a user to the product site where the user can learn more about the product and/or purchase the product.

Other product links require similar undertakings to complete a link to a creator's satisfaction. Those skilled in the art will understand how programming each type of link will work and the different user interface that may be required to complete such actions.

### Content Referral Creation—Review View

FIG. 13 depicts a smart phone 1300 displaying an example user interface 1301 similar to the example user interface 1201 shown in FIG. 12, but in a review view state of a content referral process. The example user interface 1301 includes an image 1302, a name display box 1304, a rating mechanism 1306, a dialog box 1308 and a soft keyboard 1310. As in previous examples, the image 1302 relates to a subject matter of a content referral being created. The name display box 1304 displays the name and category assigned to the content referral by the user in a previous operation. It is noted that the present display only displays one category (i.e., the “primary” category) associated with the name and the subject matter of the content referral. However, other implementations may display more than one category is more than one category is associated with the name.

The dialog box 1308 of the example user interface 1301 is configured such that a user can enter a review to associate with the content referral the user is creating. It is noted that the word “review” as used in the present context to denote a content referral creator's sentiments about a subject of a content referral that the user is creating. The word “comment” as used below, denotes a sentiment of a viewer of the content referral that is entered by the viewer with respect to an already-created content referral. The soft keyboard 1310 may be used by the user to enter characters into the dialog box 1308. In at least one implementation, the user is not be required to enter a review related to the content referral. A user review is not functionally related to the user rating, and the review function may be available without the rating function, and vice-versa, depending on the implementation.

When the user has finished entering text in the dialog box 1308, the user takes an action to commit the content referral to memory, such as actuating a home button 1312 on the phone 1300. Other methods may be used in the alternative. In addition to saving the newly-created content referral to memory other actions may be taken with respect to the content referral. As discussed below, one action that may occur is that the content referral is posted to a content referral feed, i.e., a user content referral timeline.

### Content Referral Feed

FIG. 14 depicts an example content referral feed 1400 as it might be displayed on an electronic device, such as a smart phone or personal computer. The example content referral feed 1400 includes a generic content referral template 1402, a user-created content referral 1404, and a re-created (i.e., re-posted) content referral 1406. It is noted that although only three content referrals are shown in FIG. 14, more content referrals may also make up a portion of the example content referral feed 1400. As indicated in FIG. 14, other content referrals (not shown) may be exposed by scrolling the example content referral feed 1400 up or down, through swiping gestures, arrow buttons, etc.

For purposes of the present discussion, it is assumed that the user-created content referral 1404 is a content referral created by the process shown in and described relative to previous figures herein (i.e., FIG. 3-FIG. 13). The user-created content referral 1404 depicts the look of a. content referral sing the process previously described. As mentioned above, when a user finalizes creation of a content referral by actuating the home button (or by some other method), the content referral may be inserted into a. content referral feed similar to the example content referral feed 1400 shown FIG. 14.

The user-created content referral 1404 identities a user that created the content referral in the title bar 1408 of the content referral 1404. In the present example, a user name 1410 is shown as the word “User” (used here as a generic substitute for an actual user name that identities a user see, e.g., user name 112, FIG. 1) to identify a user who created the content referral. In contrast, a title bar 1412 that is a part of the recycled content referral 1406 includes a user name 1414 “User2 Recycle” to clarify that the recycled content referral 1406 was not created by the person associated with the user name 1410 in the title bar 1408, but has been recreated by a user other than the user that created the recycled content referral 1406. In operation, “User2 Recycle” would be replaced with a typical user name.

The recycled content referral 1406 is similar to the user-created content referral 1404 on which it is based, except that it has a different user name: 1414 and it may have a different rating 1416 and/or a different review 1418. This is because a second user may recycle a content referral from a first user and enter a rating and review unique to the second user. More details on recycling content referrals is described below, with respect to FIG. 15.

### Recycled Content Referral View

FIG. 15 depicts a smart phone 1500 displaying an example user interface 1501 in a recycle view state used to create a recycled content referral. In the following discussion of FIG. 15, continuing reference is made to elements and reference numerals shown in one or more previous figures. The content referral recycle process is similar to the content referral creation process except that a user utilizes a previously created content referral to begin the process, and therefore does not have to capture media to create the content referral. The example user interface 1501 includes a digital image 1502, recycle view indicator 1504, a descriptor bar 1506, a rating mechanism 1508, a review box 1510, and a soft keyboard 1512.

As noted, the digital image 1502 is a digital image that was used in a previously created content referral. The recycle view indicator 1504 is an image that informs a user that the user in in a recycle mode. The descriptor bar 1506 includes similar displays and controls shown and described relative to the descriptor bar 116 in FIG. 1. The example user interface 1501 may be implemented without the descriptor bar 1506, but implementing the example user interface 1501 with the descriptor bar 1506 add different functionality to the example user interface 1506. In the present example, the descriptor bar 1506 shows the description (i.e. name and category) that was assigned to the original content referral. The rating mechanism 1508 in the present example is a system using from one to five stars, each star being individually actuated or one actuation of a single star actuating that particular single star plus any stars to the left of the particular single star (i.e., all lower rating stars). A different style of rating mechanism may be used in place of the star rating mechanism shown.

The review box 1510 and soft keyboard 1512 allow a user to enter a review unique to the user for association with the recycled content referral. In this manner, a user can enter a review on a content referral or subject matter thereof that was created by a different user. Any number of users can create a recycled content referral from a posted content referral, and new reviews can cycle between multiple users any number of times, such as when friends are discussing, for example, a restaurant or a movie that is the subject of a content referral.

### Content Referral Comment View

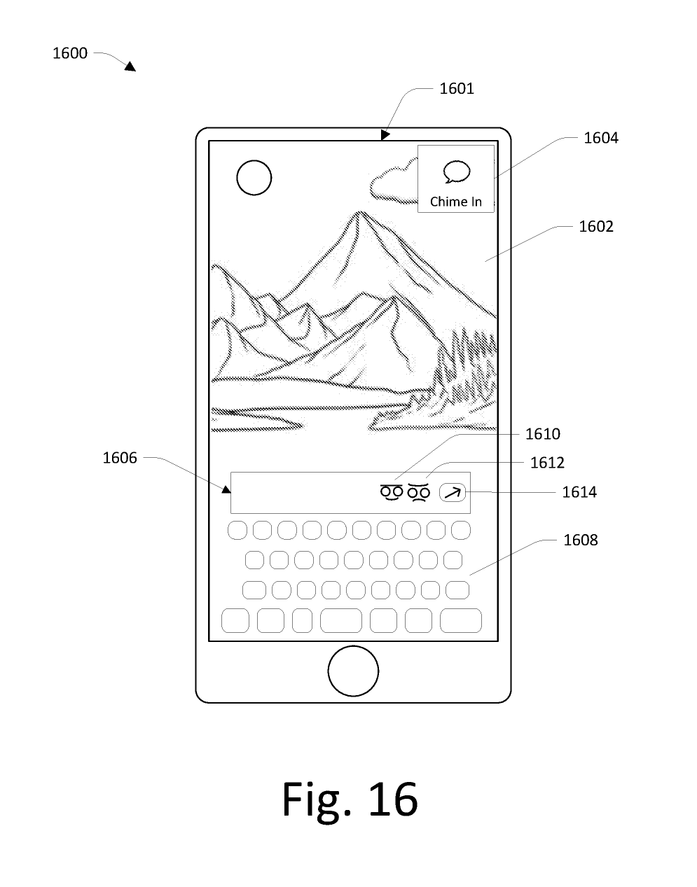

FIG. 16 depicts a smart phone 1600 displaying an example user interface 1601 in a content referral comment view state used to comment on an existing content referral. The example user interface 1601 appears in response to user actuation of the comment icon 136 (FIG. 1) of a content referral. In the following discussion of FIG. 16, continuing reference is made to elements and reference numerals shown in one or more previous figures. In the systems described herein, a user may wish to comment on a content referral that was posted by an originating user. The example user interface 1601 shown FIG. 16 may be used for that purpose. The example user interface 1601 includes a digital image 1602, a comment view indicator 1604, a comment box 1606, and a soft keyboard 1608.

The digital image 1602 is an image included with the content referral for which a comment is being entered. The comment view indicator 1604 is an icon that may be displayed to inform a user that the system is in a comment mode, whereby the user can enter a comment related to a content referral shown in the example user interface 1601. The comment box 1606 is a character entry field that displays the entered comment as characters making up the comment are entered on the soft keyboard 1608 or by some other input method. The comment box 1606 is shown having a positive comment icon 1610, a negative comment icon 1612, and a post icon 1614. In at least one implementation, the positive comment icon 1610 and the negative comment icon 1612 may be used to allow a commenter to indicate whether the commenters comment is positive or negative. Since words can carry ambiguous connotations, a commenter can make certain that his comment is understood as the commenter means it to be understood. Also, the positive comment icon 1610 or the negative comment icon 1612 may be actuated when no characters are entered for a comment. If a commenter simply wants to indicate the commenter's impression of a content referral positive or negative—without making a written comment, the commenter can only click the positive comment icon 1610 or the negative comment icon 1612 to indicate a positive or negative impression, respectively. When a user has concluded entering the user's comment, the user can actuate the post icon 1614 to post the user's comment to one or more feeds.

Comments entered by a commenter may add or subtract from a score associated with a content referral. If a comment is positive, the score is increased. Conversely, if the comment it negative, the score is decreased. In at least one implementation, scores associated with categories related to a content referral are also affected when a positive or a negative comment is discerned. In the example shown, where the subject of a content referral is “Gannett Peak,” a user may have associated such categories as “Wyoming,” “Mountains,” “Hiking,” etc. with the content referral. If so, then if a viewer enters a positive comment for the content referral, scores associated with the content referral and with each of the categories indicated above are increased. In some cases, if a category has not been explicitly associated with a content referral, but one or categories may be inferred, scores associated with the inferred categories may be positively or negatively affected by comments as well. For example, if a description of a content referral is “511@Levis®,” an inferred category might be “Men's Slim Fit Stretch Jeans” because that is what the “511” for Levis® designates.

### Content Referral Auto-Creation

Although the techniques disclosed above have focused on manual steps that may he taken by a user to create a content referral, in one or more implementations, a content referral may be wholly or partly generated automatically. When certain information items normally contained in a content referral are available by means other than a user's manual input, such information may be used to automatically generate one or more portions of a content referral. For example, if a user is viewing a page for a product that is for sale, that page will typically contain an image of the product. Rather than requiring the user to somehow capture an image of the product, the user can actuate a control to initiate a content referral auto-creation process. Likewise, other methods may be used to automatically generate a content referral. When certain things are detected, the detection may initiate an auto-generation process. Some things that may be detected to generate such a process include: transactions (e.g., with merchants, banks, cryptocurrency systems, stock exchanges; real estate systems, etc.); other monetary transactions; a code on a receipt from cash transaction; a QR code or a bar code on a product; an item displayed on a web site, an item displayed on another platform, etc.

In such an example, the image of the product contained on the site may be captured to be used as the image in a content referral, or, alternatively, a content referral may he created without an image. Other parts of a content referral, such as the personal icon and the user name may be inserted into the content referral. An item description may be copied from the product site and used as an entry in the descriptor bar of the content referral. A category for the product (which is the subject of the content referral) may be inferred from the product site, or may be looked up and retrieved from a database of products or from other content referrals that have the product as the subject matter. Automatically determining a category for a content referral may also be accomplished apart from a process that automatically generates a content referral. The same techniques may be used to automatically assign a category, for instance, when a user creates a content referral. Elements of the content referral that reflect a user's unique sentiment about the product (or whatever the subject matter of the content referral constitutes) can still be entered by the user, such as a rating and/or a review. In terms of economy of user action, one or the simplest examples is where a user automatically creates a content referral for a product that the user purchased or contemplated simply by initiating the auto-creation process and entering a rating for the product. Although the resulting content referral will not reflect a user review, all other elements of the content referral can be automatically generated.

Actions associated with a content referral may also be automatically generated. A content referral creation application may make some inferences about a subject of a content referral to create actions that are associated with the content referral. In the example discussed above, where a user auto-generates a content referral for a product that the user has contemplated, an action allowing a viewer of the auto-generated content to navigate to a site to purchase the product may be associated with the content referral. Another action may take a viewer to a review site that posts reviews of the product that is the subject of the content referral. Other types of actions may be automatically generated depending on the subject of the content referral.

A user may take further action on a content referral that is automatically generated. For example, a user may want to take the auto-created content referral and add media to it to create a new content referral. A user may also add customized actions to the auto-created content referral, adjust a score associated with the auto-created content referral, etc. Anything that a user can add to a content referral when creating a new content referral can be done to a content referral after it is created in the automatic generation process.

### Content Referral Database

FIG. 17 depicts a representation of an example content referral database 1700 that may be utilized with the techniques described herein. In the following discussion of the example content referral database 1700, continuing reference is made to elements shown in and described with respect to previous figures. It is noted that the example content referral database 1700 is only one particular implementation of a database that may be used to store information entered in content referrals. Those skilled in the art will recognize that similar databases or other storage, lookup, and recall techniques may be used with or in place of the example content referral database 1700.

The example content referral database 1700 includes multiple records, such as Record_1 1702, Record_2 1704, and Record_3 1706. The records shown are for representative purposes only and the example content referral database 1700, in practice, will contain a great number of records. Each record corresponds to a content referral created by a user, similar to the content referral 100 shown in FIG. 1. The example content referral database 1700 stores some or all of the information entered by a user when the content referral is created. Each of the records 1702-1706 stores similar information.

As shown in FIG. 17, the records 1702-1706 include a content referral identifier 1708, which is a unique identifier assigned to the content referral that corresponds to a record. The content referral identifier 1708 is assigned by a system from information entered into the content referral, or created by the system in a content referral identification subsystem. [Any specific details to mention about how these are tracked?]

Each of the records 1702-1706 also includes a user name 1710 (112, FIG. 1), content 1712 (content captured by the corresponding content referral 100, which may include any type of content), a personal icon 1714 (110, FIG. 1), a score 1716 (114, FIG. 1), and an image icon 1718 (118, FIG. 1). Each record 1702-1706 also stores a description 1720 (from the description field 120. FIG. 1), a rating 1722 (from the rating mechanism 124, FIG. 1), a review 1724 (from the review dialog box 126 FIG. 1), and one or more comments 1726 (captured from other users' comments on the corresponding content referral 100). The records 1702-1706 in the example content referral database 1700 also include one or more categories 1728 that have been assigned to the corresponding content referral 100 by the user, a location 1730 of the subject of the corresponding content referral 100 (if applicable), a number of likes 1732 that the corresponding content referral 100 receives from users other than the user that created the content referral 100, a number of recycles 1734 that have used one or more elements of the corresponding content referral 100, and a number of shares 1736 of the corresponding content referral 100.

Each of the records 1702-1706 also includes entries for thanks 1738 and action 1740. The thanks 1738 entry is used to store the name of one or more persons that have credited a user for a referral to a place, product, or thing that is the subject matter of a content referral associated with the record 1702-1706. Action 1740 list one or more actions that a user who created the content referral has made available to a person who view the content referral (such as purchase a product, etc.).

Any information included in a content referral, whether it is entered by a user or captured from a source other than the user, may be stored in a record of the content referral database 1700. To support a search function, the content referral database 1700 is searchable on any element or combination of elements. Further characteristics of the example content referral database 1700 are described in the context of certain functions, below.

### Lists Database

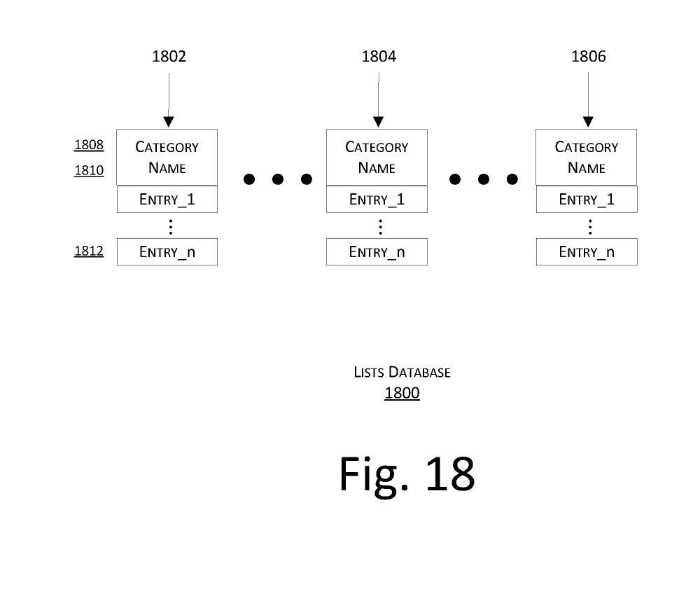

FIG. 18 depicts a representation of an example lists database 1800 that may be utilized with the techniques described herein. In the following discussion of the example lists database 1800, continuing reference is made to elements shown in and described with respect to previous figures. It is noted that the example lists database 1800 is only one particular implementation of a database that may be used to store list information related to content referrals. Those skilled in the art will recognize that similar databases or other storage, lookup, and recall techniques may be used with or in place of the example lists database 1800.

The example lists database 1800 stores multiple records, as illustrated by Record_1 1802, Record_2 1804, and Record_3 1806. Although only three records 1802-1806 are shown in the present example, many more records will be stored in the lists database 1800 in operation. Each record 1802-1806 of the example lists database 1800 includes a category name 1808 and one or more entries in a list associated with the category name 1808. The category name 1808 is taken from the description field 120 (FIG. 1) in a content referral. As previously notes, a description in the description field 120 is in a format of name@category, thus the category is a string of characters following the connecting symbol used in a particular implementation (in the present example, the connecting symbol is “@”).

Each record 1802-1806 also includes a first entry, Entry_1 1810, and other entries culminating with Entry_n 1812. A record 1802-1806 may only include a single entry (Entry_1 1810), but will typically include multiple entries. A maximum number of entries for each category may vary between implementations. For example, one or more implementations may utilize “Top Ten” lists and, therefore, limit a number of entries associated with a category to ten (10). In one or more alternate implementations, a maximum of forth (40) entries per category may be allowed for example. In other implementations, a number of entries may not be limited at all.

### Example System—Electronic Device

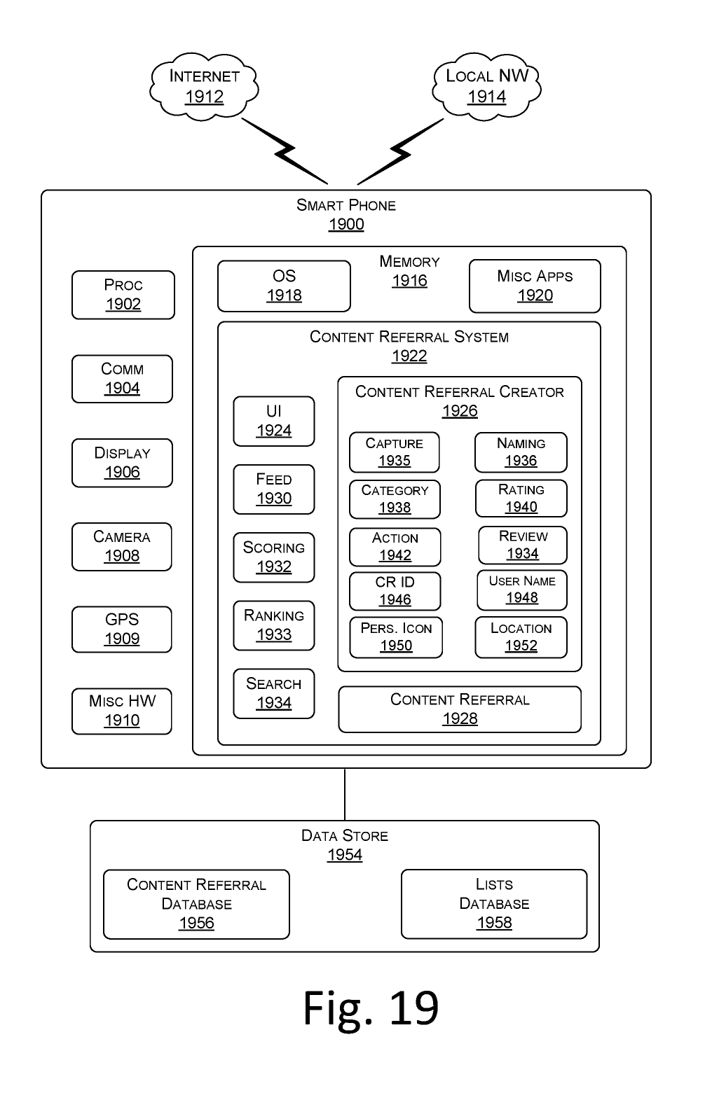

FIG. 19 is a block diagram representing an example electronic device on which one or more portions of the present inventions may be implemented. In this particular example, the example electronic device is a smart phone 1900, but similar techniques would be employed on any other suitable type of electronic device, such as a tablet or a computer.

In the following discussion, particular names have been assigned to individual components of the example smart phone 1900. It is noted that a name of an element is exemplary only, and that a name is not meant to limit a scope or function of an associated element. Furthermore, certain interactions may be attributed to particular components. It is noted that in at least one alternative implementation not particularly described herein, other component interactions and communications may be provided. The following discussion of FIG. 19 merely represents a subset of all possible implementations. Furthermore, although other implementations may differ, one or more elements of the example smart phone 1900 are described as a software application that includes, and has components that include, code segments of processor-executable instructions. As such, certain properties attributed to a particular component in the present description, may be performed by one or more other components in an alternate implementation. An alternate attribution of properties, or functions, within the example smart phone 1900 is not intended to limit the scope of the techniques described herein or the claims appended hereto.

The example smart phone 1900 includes one or more processors 1902, one or more communication interfaces 1904, a display 1906. a camera 1908, and miscellaneous hardware 1910. Each of the one or more processors 1902 may be a single-core processor or a multi-core processor. The communication interface(s) 1904 facilitates communication with components located outside the example smart phone 1900, and provides networking capabilities for the example smart phone 1900. For example, the example smart phone 1900, by way of the communications interface 1904, may exchange data with other electronic devices (e.g., laptops, computers, other servers, etc.) via one or more networks, such as the Internet 1912 or a local network 1914. Communications between the example smart phone 1900 and other electronic devices may utilize any sort of communication protocol known in the art for sending and receiving data and/or voice communications.

The display 1906 is a typical smart phone display in the present example, but may be an external display used with a smart phone or other type of electronic device. The camera 1908 is shown integrated into the example smart phone 1900, but may be an external camera used with the example smart phone 1900 or a different type of electronic device. A Global Positioning System 1909 or some other type of location-determining component is included. The miscellaneous hardware 1910 includes hardware components and associated software and/or or firmware used to carry out device operations. Included in the miscellaneous hardware 1910 are one or more user interface hardware components not shown individually—such as a keyboard, a mouse, a display, a microphone, a camera, and/or the like—that support user interaction with the example smart phone 1900 or other type of electronic device.

The example smart phone 1900 also includes memory 1916 that stores data, executable instructions, modules, components, data structures, etc. The memory 1916 can be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 1918 is stored in the memory 1916 of the example smart phone 1900. The operating system 1918 controls functionality of the processors) 1902, the communications interface(2) 1904, the display 1906, the camera 1908, and the miscellaneous hardware 1910. Furthermore, the operating system 1918 includes components that enable the example smart phone 1900 to receive and transmit data via various inputs (e.g., user controls, network interfaces, and/or memory devices), as well as process data using the processor(s) 1902 to generate output. The operating system 1918 can include a presentation component that controls presentation of output (e.g., display the data. on an electronic display, store the data in memory, transmit the data to another electronic device, etc.). Additionally, the operating system 1918 can include other components that perform various additional functions generally associated with a typical operating system. The memory 1916 also stores miscellaneous software applications 1920, or programs, that provide or support functionality for the example smart phone 1900, or provide a general or specialized device user function that may or may not be related to the example smart phone 1900 per se. The software applications 1920 include system software applications and executable applications that carry out non-system functions.

The memory 1916 also stores a content referral system 1922 that performs and/or controls operations to carry out the techniques presented herein and includes several components that work together to provide the improved systems, methods, etc., presently described. The content referral system 1922 includes a user interface 1924, a content referral creator 1926, and a content referral 1928. The user interface 1924 contains elements that support input and output communications between the example smart phone 1900 and a user thereof. The user interface 1924 also provides functionality for some user interface elements, such as functions represented by the widget icons 128 of FIG. 1 (i.e., functionality for attributes, like, recycle, comment, thanks, forward). The content referral creator 1926 supports functionality that allows a user to create a content referral (see 100, FIG. 1) as described herein. The content referral 1928 is created by the content referral creator 1926. The content referral 1928, while not always present in the memory 1916, is shown to represent a content referral such as the example content referral 100 (FIG. 1). Typically, the content referral 1928 includes the data stored in a record of the example content referral database 1700 (FIG. 17). The content referral system 1922 also includes a feed 1930 that generates and stores a user feed similar to the feed 1400 shown in and described with respect to FIG. 14. The content referral system 1922 also includes a scoring module 1932, a ranking module 1933, and a search module 1934.

The content referral creator 1926 includes functional elements that create the content referral 1928. The content referral creator 1926 includes a capture component 1935 that provides functionality to capture media content used in a content referral, be it a single image, multiple images, audio, etc, (see, e.g., FIG. 4). In the present example, the capture component 1935 is also configured to create an image icon 118 (FIG. 1) associated with the captured media content. The content creator 1926 also includes a naming component 1936, a category module 1938, a rating component 1940, an action component 1942, and a review component 1944. The naming component 1936 supports functionality to receive a name for a content referral (see, e.g. FIGS. 5 and 6). The category module 1938 is configured to support the functionality described with respect to FIGS. 7-9 for identifying categories to be associated with the content referral. The rating component 1940 provides functionality to support the rating process (see, e.g. FIG. 10). The action component 1942 is configured to provide supporting functionality for associating one or more actions to be associated with the content referral, as describe with respect to FIGS. 11 and 12. The review component 1944 provides the functionality for receiving and storing a review from the user, as described above in relation to FIG. 13.

The content referral creator 1926 also includes a content referral identifier module 1946, a user name 1948, a personal icon 1950, and a location 1952. The content referral identifier module 1946 creates and stores a content referral identifier 1708 (FIG. 171) that uniquely identifies an associated content referral. The user name 1948 is a user name associated with a user that creates a content referral, and will typically be an owner of the example smart phone 1900 or other electronic device. The personal icon 1950 is an icon chosen by a user to represent the user in the content referral system 1926, in tent referrals, comments and ratings on other content referrals, and the like. The location 1952 is a value that identifies a location associated with a content referral being created, such as geographical coordinates obtained from the GPS 1909 when content associated with the content referral is captured.

The example smart phone 1900 communicates with a data store 1954 that stores a content referral database 1956 (similar to the example content referral database 1700 shown in and described with respect to FIG. 17) and a lists database 1958 (similar to the example lists database 1800 shown in and described with respect to FIG. 18). Although shown located external to the example smart phone 1900, at least some of the data stored in the data store may be located in the memory 1916 of the example smart phone 1900. Typically, however, the content referral system 1922 communicates with an external data store 1954 to have access to the full features of content referrals and supporting applications associated with the content referral system.

Those skilled in the art will appreciate that variances on the described implementation(s) may be implemented to take advantage of system characteristics and provide an efficient operating environment.

### Example Server

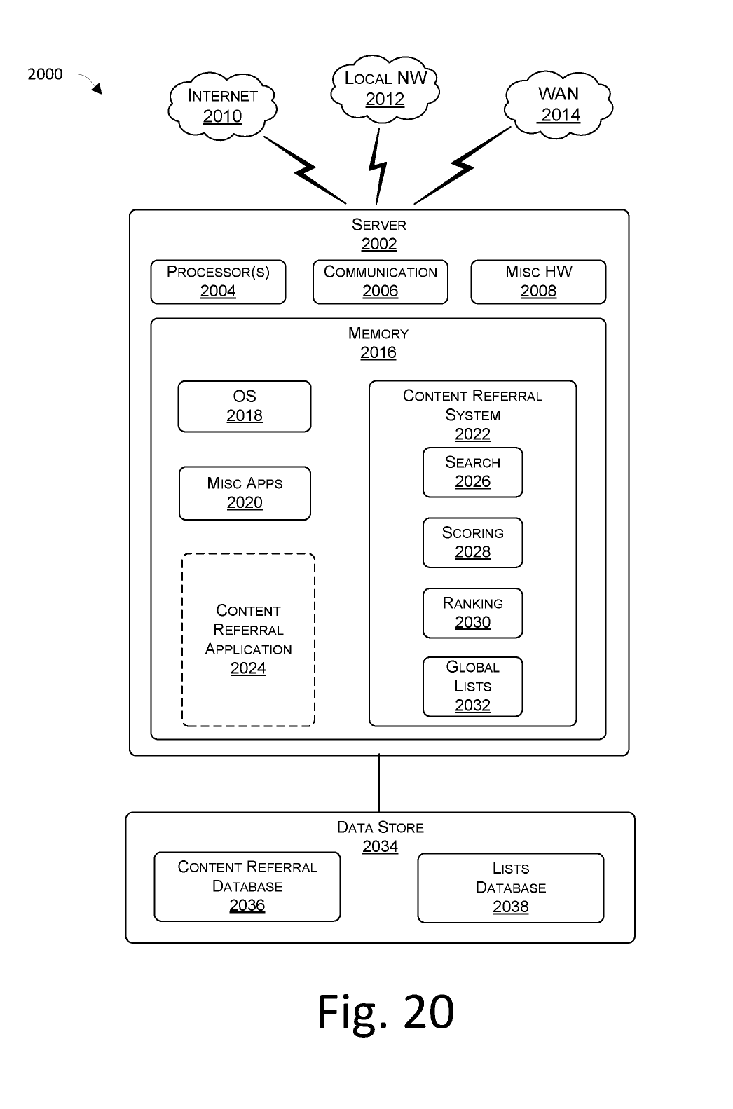

FIG. 20 is a block diagram depicting an example server operational environment 2000 in accordance with the techniques described herein. In the following discussion, particular names have been assigned to individual components of the example server operational environment 2000. It is noted that a name of an element is exemplary only, and that a name is not meant to limit a scope or function of an associated element. Furthermore, certain interactions may be attributed to particular components. It is noted that in at least one alternative implementation not particularly described herein, other component interactions and communications may be provided. The following discussion of FIG. 20 merely represents a subset of all possible implementations. Furthermore, although other implementations may differ, one or more elements of the example server operational environment 2000 are described as a software application that includes, and has components that include, code segments of processor-executable instructions. As such, certain properties attributed to a particular component in the present description, may be performed by one or more other components in an alternate implementation. An alternate attribution of properties, or functions, within the example server operational environment 2000 is not intended to limit the scope of the techniques described herein or the claims appended hereto.

The example server operational environment 2000 contains a server 2002 that includes one or more processors 2004, one or more communication interfaces 2006, and miscellaneous hardware 2008. Each of the one or more processors 2004 may be a single-core processor or a multi-core processor. The communication interface(s) 2006 facilitates communication with components located outside the server 2002, and provides networking capabilities for the server 2002. For example, the server 2002, by way of the communications interface(s) 2006, may exchange data with client electronic devices (e.g., laptops, computers, other servers, etc.) via one or more networks, such as the Internet 2010, a wide area network 2012, or a local network 2014. Communications between the example server 2002 and other electronic devices may utilize any sort of communication protocol known in the art for sending and receiving data and/or voice communications.

The miscellaneous hardware 2008 of the server 2002 includes hardware components and associated software and/or or firmware used to carry out server operations. Included in the miscellaneous hardware 2008 are one or more user interface hardware components not shown individually—such as a keyboard, a mouse, a display, a microphone, a camera, and/or the like—that support user interaction with the server 2002 or other type of electronic device.

The server 2002 also includes memory 2016 that stores data, executable instructions, modules, components, data structures, etc. The memory 2016 can be implemented using computer readable media as previously described (see paragraph [0102], supra. An operating system 2018 is stored in the memory 2016 of the server 2002. The operating system 2018 controls functionality of the processor(s) 2004, the communications interface(s) 2006, miscellaneous hardware 2008. Furthermore, the operating system 2018 includes components that enable the server 2002 to receive and transmit data via various inputs (e.g., user controls, network interfaces, and/or memory devices), as well as process data using the processor(s) 2004 to generate output. The operating system 2018 can include a presentation component that controls presentation of output (e.g., display the data on an electronic display, store the data in memory, transmit the data to another electronic device, etc.). Additionally, the operating system 2018 can include other components that perform various additional functions generally associated with a typical operating system. The memory 2016 also stores miscellaneous software applications 2020, or programs, that provide or support functionality for the server 2002, or provide a general or specialized device user function that may or may not be related to the server 2002 per se. The software applications 2020 include system software applications and executable applications that carry out non-system functions.

The memory 2016 also stores a content referral system 2022 that performs and/or controls operations to carry out the techniques presented herein and includes several components that work together to provide the improved systems, methods, etc., presently described. In addition to supporting services available through the content referral system 1922 on the example smart phone 1900 shown in FIG. 19, the content referral system 2022 of the server 2002 also performs global operations that function across multiple users, such as creating global lists, global scoring, global ranking, etc.

It is noted that although the presently described implementations contemplate individual users executing a content referral system on a personal device, the server 2002 may include one or more instances of a client content referral system 2024. In such a system, the core functionality of the content referral system is executed primarily on the server 2002, and peripheral functionality, such as user input and output, content capture, etc., are performed on a user electronic device associated with an instance of a client content referral system.

The content referral system 2022 includes a search component 2026, a scoring component 2028, a ranking component 2030, and a global lists component 2032. The search component 2026 is configured to receiving a search term from a client device and search an associated data store 2034 for relevant information. The data store 2034 shown in FIG. 20, can store many data items, such as user information, user feeds, user lists, global lists, product information, geographic information, business information, etc. The data stored is shown storing a content referral database 2036 and a lists database 2038 that are similar to those previously described. The data store 2034 may be stored in the memory 2016 of the server 2002 or it may be ed in an external location that is accessible by the server 2002. The scoring component 2028 tracks activity associated with a subject of a content referral and adds or subtracts points based on various user input with respect to the content referral.

For example, the scoring component 2028 may track a user's actions when the user is creating a content referral, such as increasing a score when a user enters a higher rating and decreasing the score when the user enters a lower rating. Other factors, such as a positive review from a creator may be used in this regard. The scoring component 2028 may also track external factors to derive a score. For example, if a subject of a content referral is a company, the scoring component 2028 may track news about the company, a stock price of company stock, and similar things related to the company to increase or decrease the score associated with the company. The scoring component 2028 may also track actions by other users with regard to a content referral to derive a score for a subject of the content referral. In such a context, a score for a product that is the subject of a content referral may increase when a user actuates a “like” icon associated with the content referral, and may decrease if a negative reaction from a user is detected (by way of a negative comment, a lower rating, etc). Virtually any indicator of a person's sentiment regarding a subject of a content referral may be used to derive a score associated with the subject.

The ranking component 2030 is configured to rank different items within a category to order the items according to a score calculated by the scoring component 2028. For example, if there is a category of restaurants, the ranking component will determine the ranked order of all content referrals related to an item associated with the restaurant category. Such ranking may be limited to a maximum number of items, such as ten (10), forty (40), or any other practicable number. The ranked order of items in a category are stored as lists in the global lists 2032. The lists are global lists because they are lists that take into account content referrals created by multiple users in the system, whereas personal lists are rankings of one user's items in a category.

### Example Methodological Implementation—Ranking

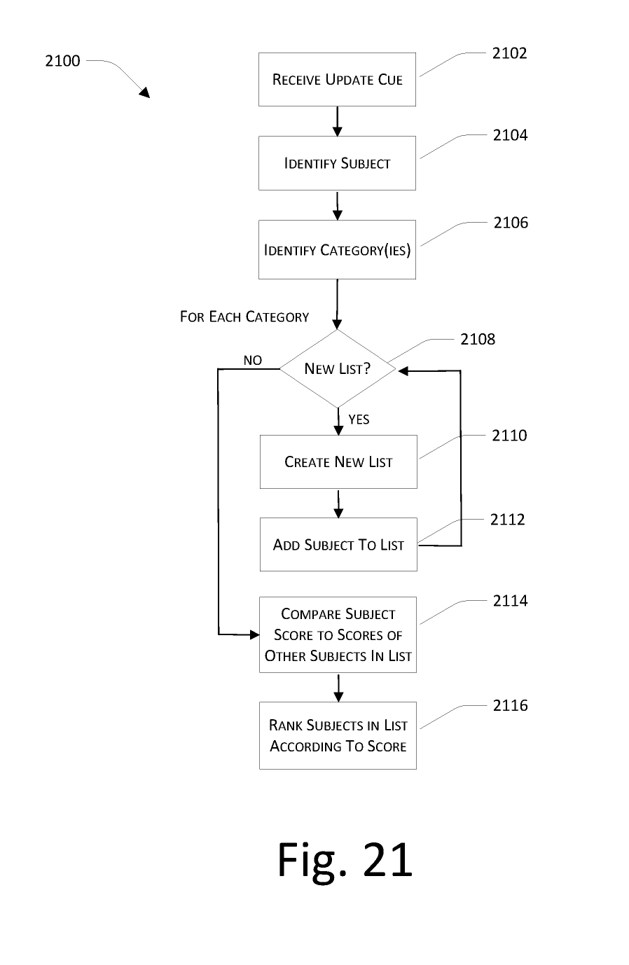

FIG. 21 is a flow diagram 2100 that depicts an example methodological implementation for ranking for use in the techniques presented herein. In the following discussion of the flow diagram 2100, continuing reference may be made to the element names and/or reference numerals shown in previous figures. It is noted that although particular steps are described in the following discussion of the flow diagram 2100, more or fewer steps may be included in an alternative methodological implementation. Furthermore, two or more discrete steps shown in and described with respect to the flow diagram 2100 may be combined into a single step in a logical implementation of one or more of the techniques described herein.

Ranked lists may be created in one or more of various ways. In at least one implementation described herein, ranked lists are ordered according to scores of subject in categories. As previously noted, each content referral has a corresponding subject and at least one category. A list is a category, such as Italian restaurants, purses, favorite comedy actresses, and the like. Each list is made up of subjects that have been associated with a name of a category corresponding with the list in one or more content referrals (e.g, in the description field 120 (FIG. 1). Lists may be personal (i.e., all list items are created from content referrals created by a user), or they may be global (i.e., list items created from content referrals created by any user in a system). The following discussion of the flow diagram 2100 describes one method by which ranked lists are created and/or maintained.

Scores for subjects or items may frequently change. Therefore, to keep lists in an order consistent with the latest scores, certain events (cues) can trigger a re-ordering of lists. At step 2102, a scoring update cue is received by the ranking module 1933 of the content referral system 1922 (FIG. 19) id/or the ranking module 2030 of the content referral system 2022 (FIG. 20). Scoring updates may cue off of many types of internal events, such as when a user posts a new content referral, when a user takes an action with regard to a content referral (like, share, recycle, thanks, etc.), when a user adjusts a score for a content referral, etc. External events (e.g., news regarding a subject, any external factors identified above, etc.) may also change a score, which can cue a reordering process.

At step 2104, a subject of an event that caused the cue is identified, and a category or categories for the subject is/are identified at step 2106. Steps 2018 through 2116 are performed for each identified category. If there is not an existing list that matches the identified category (“Yes” branch, step 2108), a new list is created for the category at step 2110, and the subject is added to the new list at step 2112, and the process reverts to step 2108 for additional categories identified as corresponding to the subject. If an existing list matches the identified category (“No” branch, step 2108), then a score for the subject is compared to scores of other subjects in the list at step 2114, and the subjects in the list are ranked according to their corresponding scores.

Many implementation variations exist for scoring and ranking processes, and the limited examples provided herein are not meant to exemplify each such process. Those skilled in the art will recognize how scores and ranked lists can be utilized to provide a basis for an efficient search process, described below.

### Example Methodological Implementation—Search

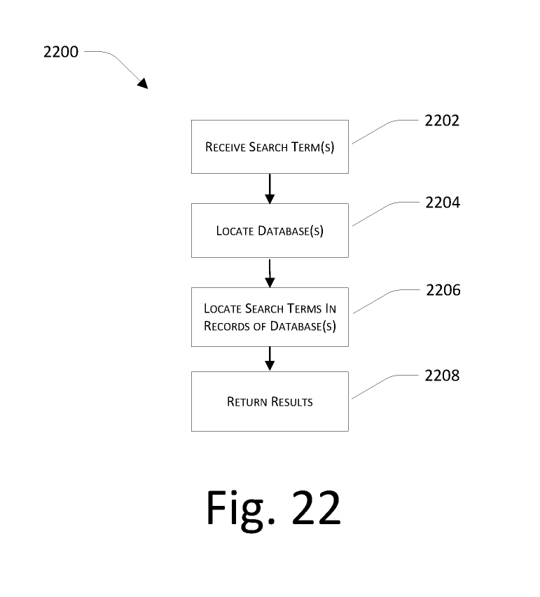

FIG. 22 is a flow diagram 2200 that depicts an example methodological implementation for search for use in the techniques presented herein. In the following discussion of the flow diagram 2200, continuing reference may be made to the element names and/or reference numerals shown in previous figures. It is noted that although particular steps are described in the following discussion of the flow diagram 2200, more or fewer steps may be included in an alternative methodological implementation. Furthermore, two or more discrete steps shown in and described with respect to the flow diagram 2200 may be combined into a single step in a logical implementation of one or more of the techniques described herein.

Algorithms, applications, processes, methods, etc., for searching datasets is numerous, varied, and well-known in the art. Any particular technique for searching for search terms in a data set (i.e., a list) as described herein may be utilized with other aspects of the present description. One of the innovations disclosed herein is that the data set that is searched is a data set from data items created by known users. In other words, when a user performs a search, the search is performed over data that has been created by user contacts, known users (such as a celebrity or an expert), a group of users having a particular knowledge (such as people that live within a certain distance from a particular restaurant), etc. The flow diagram 2200 provides a particular method of searching lists, but variations on the described method may be implemented without departing from the scope of the present description.

At step 2202, a user enters a search term that is received by the search component 1934 of the content referral system 1922 (FIG. 19) and/or the search component 2026 of the content referral system 2022 (FIG. 20). For example, a user may enter a name of a particular restaurant, a category of restaurants in a particular location, a product, a person, and/or the like. At step 2204, the search component 1934 or the search component 2026 determines one or more databases that will be searched to satisfy the search query. Searchable databases may be located on the smart phone 1900 or the server 2002 and database containing different types of information may be searched, such as the content referral database 1969 or the lists database 1970 in the datastore 1966 of the smart phone 1900 (FIG. 19), or the content referral database 2034 or the lists database 2036 in the datastore 2034 of the server 2002, or any other external or internal database. Records in the relevant database(s) is/are searched to determine if the search term is found therein (step 2206) and, if found, search results are returned at step 2208.

### CONCLUSION

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method, comprising:
providing a content referral user interface for creating a content referral;
receiving content referral information by way of the content referral user interface, said content referral information including at least a subject, a category, and a rating;
calculating a score for the subject and associating said score with the content referral information;
storing the received content referral information and associated score in a content record of a content record data store;
creating a ranked list of subjects from content records having an identical or associated category as the category of the content referral information, the subjects ranked according to scores associated with the content records and the score associated with the received content referral information;
storing the ranked list in a list store; and
wherein the list store includes multiple lists that serve as a data set for a search operation.

2. The method as recited in claim 1, wherein the score associated with the content referral information is based on the rating included in the content referral information.

3. The method as recited in claim 1, wherein the score associated with the content referral information is based on external factors related to the subject included in the content referral information.

4. The method as recited in claim 1, wherein the content referral information further comprises a review.

5. The method as recited in claim 1, wherein the content referral information further comprises additional categories that are associated with the subject.

6. The method as recited in claim 1, wherein the content referral information further comprises at least one action that is associated with the content referral information.

7. The method as recited in claim 1, wherein the content referral information further comprises digital content that depicts the subject of the content referral information.

8. The method as recited in claim 1, further comprising creating a content referral that includes at least the content referral information, and inserting the content referral in a content referral feed associated with a user that entered the content referral information.

9. The method as recited in claim 1, further comprising creating a content referral that includes at least the content referral information, and associating an action with the content referral so that the associated action may be performed from the content referral.

10. The method as recited in claim 10, wherein the associating an action wi content referral is performed automatically upon detection of an item or state.

11. One or more computer-readable storage media storing computer-executable instructions that, when executed, display a content referral user interface related to a subject, the content referral user interface including:
a subject name;
a subject category;
content related to the subject;
one or more actuatable icons, each representing a function that is executed upon actuation of the icon; and
wherein the computer-readable storage media stores additional computer-executable instructions that, when executed, perform the following steps:
retrieving a starting score associated with the subject name and subject category;
monitoring user interactions with the content referral user interface;
adjusting the starting score based on the monitored user interactions to derive a final score; and
storing the final score such that the final score is associated with the subject name and subject category.

12. The one or more computer-readable storage media as recited in claim 11, wherein one of the actuatable icons further comprises a thanks icon that, when actuated, indicates that a user actuating the icon performs or intends to perform an action in response to the subject displayed in the content referral user interface.

13. The one or more computer-readable storage media as recited in claim 11, wherein one of the actuatable icons further comprises a re-create icon that, when actuated, allows a user to use one or more elements displayed in the content referral user interface in a new content referral user interface created by the user.

14. The one or more computer-readable storage media as recited in claim 11, wherein one of the actuatable icons further comprises an action icon that, when actuated, presents one or more actions that a user can take relative to the content referral user interface.

15. The one or more computer-readable storage media as recited in claim 11, wherein one of the actuatable icons comprises a comment icon that, when actuated, allows a viewer to enter a comment related to the subject of the content referral user interface.

16. The one or more computer-readable storage media as recited in claim 11, wherein a content referral is created from information included in the content referral user interface, and the content referral is posted in a content referral feed associated with the viewer.

17. The one or more computer-readable storage media as recited in claim 11, wherein one of the actuatable icons comprises a top ten icon that, when executed, displays one or more ranked lists that include the subject name and subject category.

18. A smart phone, comprising:
a processor;
memory;
a content referral system stored in the memory configured to create and process content referrals, the content referral system including:
a capture component configured to capture media content for a content referral;
a naming component configured to identify a subject name for the content referral:
a category module configured to identify a category for the content referral:
a rating component configured to receive a rating for the content referral;
a scoring module configured to manipulate a score associated with the content referral, said score based on user interactions with the content referral; and
a ranking module configured to rank the content referral relative to other content referrals having the same category as the category identified for the content referral.

19. The smart phone as recited in claim 18, further comprising a search component configured to receive a search query and search content referral records in a content referral database.

20. The smart phone as recited in claim 18, further comprising a content referral database that stores multiple content referrals.

21. The smart phone as recited in claim 18, further comprising a lists database that stores ranked lists of content referrals, each ranked list associated with a category from at least one content referral.

22. The smart phone as recited in claim 18, further comprising a content referral feed component configured to display one or more content referrals that are associated with a user or with an entity identified by the user.
